(19) United States
(12) Patent Application Publication
(10) Pub. No.: US 2011/0127174 A1
(43) Pub. Date: Jun. 2, 2011

(54) STORAGE TANK FOR GASEOUS FUELS, AND USE THEREOF

(76) Inventors: Peter Heinrich, Moers (DE); Stefan Kämper, Ratingen (DE); Julian Michelsen, Bayreuth (DE); Florian Michl, Munchen (DE); Walter Schütz, Weidenberg (DE)

(21) Appl. No.: 12/666,425

(22) PCT Filed: Apr. 25, 2008
(86) PCT No.: PCT/EP2008/003350

§ 371 Date: Nov. 19, 2010

(30) Foreign Application Priority Data
Jun. 27, 2007 (DE) 10 2007 030 140.7
Jul. 16, 2007 (DE) 10 2007 033 368.6

(51) Int. Cl. B65B 3/00; B65B 1/04; B23P 11/00

(52) U.S. Cl. 206/7; 141/311 R; 29/428

(57) ABSTRACT

The invention relates to a storage tank for storing a sorbent material. Said storage tank comprises a pressure vessel, a connecting element to an external supply system, at least on sorbent material which contains a sorbent and an adsorbate that adsorbs thereto, especially a gaseous fuel, preferably hydrogen, and which is stored in the storage tank at least during proper use of the storage tank, and a conduit for feeding and/or discharging sorbent material into/from the storage tank. At least one second duct is provided for supplying and/or evacuating a gas (gas duct). The sorbent is formed on the basis of heavy-duty adsorbents based on activated carbon in the form of discrete, activated carbon grains, preferably spherical ones. At least 70 percent of the entire pore volume of the heavy-duty adsorbents are formed by microspores having a diameter of ≦20.

### CROSS-REFERENCES TO RELATED APPLICATIONS

This application is a National Stage filing of International Application PCT/EP2008/003350, filed Apr. 25, 2008, claiming priority to German Applications No. DE 10 2007 030 140.7 filed Jun. 27, 2007, and No. DE 10 2007 033 368.6 filed Jul. 16, 2007, entitled “Storage Tank for Gaseous Fuels, and Use Thereof”. The subject application claims priority to PCT/EP2008/003350 and to German Applications No. DE 10 2007 030 140.7 and No. DE 10 2007 033 368.6 and incorporates all by reference herein, in their entirety.

### BACKGROUND OF THE INVENTION

The present invention relates to the technical field of storage and provision of gaseous fuels such as, in particular, hydrogen. In this context, the present invention relates particularly to a storage container for gaseous fuels and uses thereof.

In particular, the present invention relates to a storage container according to the preamble of claim 1, a tank system according to the preamble of claim 21, a charging/discharging connection according to the preamble of claim 24 for charging and/or discharging a storage container, a system for providing sorption material according to the preamble of claim 29, a method of providing sorption material for a storage container according to the preamble of claim 36 and a method of charging a storage container according to the preamble of claim 39.

Storage containers can, for example, be configured as adsorption storages. The invention is naturally not restricted to this particular use. The storage system according to the present invention can in principle be employed for any type of storage in which a storage container, in particular a storage container consisting of an inner container and an outer container, is utilized to take up a medium to be stored, for example a gas, a liquid or possibly also a different type of charge, in a solid.

However, the invention will in the following be described and explained mainly for an adsorption storage system.

In particular, the present invention relates to the technical field of hydrogen storage which has recently attained considerably increased importance.

Hydrogen is considered to be a zero-emission fuel in respect of emissions of toxic or climate-influencing process gases because its use, for example in thermal internal combustion engines, in fuel cell applications or the like produces virtually only water. The provision of suitable storage materials for efficient storage of hydrogen is consequently an important aim which has to be achieved before widespread use of hydrogen as fuel can become established.

It is known in principle that hydrogen can be adsorbed on suitable adsorption materials (e.g. materials based on carbon), for the purposes of the invention referred to synonymously as sorbent or sorbents. Such adsorption materials are, for example, activated carbon. For the purposes of the present invention, adsorption means the attachment of gases or dissolved materials to the surface of a solid or liquid phase, known as the sorbent. The sorbent serves, for example, as storage material for the hydrogen. The term “sorbent”, plural “sorbents”, is used in the context of the present invention to refer to the adsorption or storage material (e.g. activated carbon) as such (for the purposes of the present invention, the more specific term “adsorbent” or “adsorbents” will occasionally also be used synonymously); on the other hand, the term “sorption material” will be used in the context of the present invention to refer, as a distinction from the term sorbent, to the sorbent together with the adsorbed material or gas, viz. the adsorbate (for example the adsorbent with the gaseous fuel adsorbed thereon, e.g. the activated carbon with the hydrogen adsorbed thereon), i.e. expressed as an equation:

sorbent (e.g. activated carbon)+adsorbate (e.g. H₂)=sorption material.

The storage or sorption material is preferably accommodated in a storage container, viz. the adsorption container, in which hydrogen is stored.

The hydrogen is taken off by means of desorption. This is the process opposite to adsorption. When reference is made to the process of adsorption in the further course of the description, the process of desorption should naturally always also be encompassed. In desorption, the hydrogen adsorbed on the adsorption material is released or detached or separated from the sorbent or sorption material with introduction of energy.

The problem in the adsorption of media on adsorption materials is often the management of the heat flows which occur, i.e. adsorption energies or desorption energies in the case of adsorption or desorption. Thus, local cooling or overheating of the adsorbents can occur since the adsorbents such as activated carbon having a high specific surface area have only poor thermal conductivities. Convection as a means of transporting heat in the gas phase is also greatly restricted owing to the large frictional losses at the pore walls of the adsorbents. The kinetics of adsorption and desorption are also limited substantially by the slow gas transport through the porous structure of the adsorbents.

As indicated above, the sorbents are usually porous and have a high specific surface area. They therefore often have a very poor thermal conductivity. When hydrogen or another gas is adsorbed thereon, heat of adsorption is evolved and heats the material so that part of the adsorbed gas is desorbed again. Attempts therefore have to be made to transport away the heat. An analogous situation also applies to desorption. In this case, heat has to be supplied to the adsorption materials in order to bring about desorption.

To store gases by adsorption, in particular on high surface materials, the temperature of the storage system and of the storage medium, for example a gas, is advantageously lowered to the cryogenic region in order to achieve better storage capacities. This requires the removal of a large quantity of energy. This is added to by the energy liberated by adsorption of the storage medium, which likewise has to be removed. On the other hand, to drive off the storage medium, energy has to be supplied to the storage system to increase its temperature to the region of room temperature and provide the necessary desorption energy.

For these two dynamic processes of the storage system to be able to take place as quickly as possible, efficient energy supply or efficient energy removal is necessary.

A number of solutions which are concerned with the storage of hydrogen, in particular the adsorption and desorption problems, are known in the prior art. For example, WO 2005/044452 A2 describes a storage system for storing a medium, for example hydrogen, and a method of charging/discharging a storage system containing a storage medium. The storage system has a storage container which is advantageously configured as a pressure vessel. A storage material is present in the form of a sorbent in this storage container. A gas to be stored, for example hydrogen, is introduced into the storage container and adsorbed on the sorbent under suitable conditions. To take off the gas, it is subsequently firstly desorbed. The sorbent remains in the storage container for the entire time; adsorption consequently takes place within the storage container.

DE 10 2005 023 036 A1 also proceeds from a sorbent or sorption material remaining in a tank system. The large amounts of heat of adsorption evolved during charging have to be removed from the tank system. This requires a heat exchanger in the tank system and costs a great deal of time during filling of the tank. DE 26 15 630 A1 describes a cooling device for cooling a high-pressure tank.

A great problem of sorption storages is the removal of the heat of sorption liberated during filling of the tank. The enthalpy of sorption liberated during filling of the tank has to be removed in a short time. A heat exchanger having an appropriately large cooling capacity is necessary for this process. Apart from the problem of transporting away large amounts of coolant, the necessity of removing the heat significantly prolongs the filling of the tank. In addition, the additional volume and weight reduces the volumetric and gravimetric storage capacities and also increases the costs incurred for decentralized heat management.

### BRIEF SUMMARY OF THE INVENTION

It is an object of the present invention to provide solutions by means of which the abovementioned disadvantages can be largely avoided or at least decreased. In particular, solutions for storing gases, in particular hydrogen, by means of which the heat of sorption evolved can be removed, in particular without time problems and at low cost and low energy consumption, are to be provided.

This object is achieved according to the invention by the storage container having the features of independent claim 1, the tank system having the features of independent claim 21, the charging/discharging connection having the features of independent claim 24, the system having the features of independent claim 29, the method of providing a sorption material having the features of independent claim 36 and the method of charging a storage container according to independent claim 39. Further features, embodiments, variants and details of the invention can be derived from the respective dependent claims, the description and the drawings. Here, features, embodiments, variants and details described in connection with a particular aspect of the invention naturally also apply in connection with other aspects of the invention, and vice versa.

### BRIEF DESCRIPTION OF THE DRAWINGS

FIG. 1 shows a first embodiment of a storage container for the storage of gaseous fuels.

FIG. 2 shows the storage container of FIG. 1, discharging adsorbent, as carried out at a filling station.

FIG. 3 shows the storage container of FIG. 1, charging adsorbent, as carried out at a filling station.

FIG. 4 shows the storage container of FIG. 1, under the conditions of travel.

FIG. 5 shows a further embodiment of a storage container for the storage of gaseous fuels wherein the container makes use of the dynamic pressure drop to increase the gas's flow velocity.

FIG. 6 shows the storage container of FIG. 5, discharging adsorbent, as carried out at a filling station.

FIG. 7 shows the storage container of FIG. 5, charging adsorbent, as carried out at a filling station.

FIG. 8 shows the storage container of FIG. 5, under the conditions of travel.

FIG. 9 shows a further embodiment of a storage container for the storage of gaseous fuels.

FIG. 10 shows the storage container of FIG. 9, discharging adsorbent, as carried out at a filling station.

FIG. 11 shows the storage container of FIG. 9, charging adsorbent, as carried out at a filling station.

FIG. 12 shows the storage container of FIG. 9, under the conditions of travel.

FIG. 13 illustrates a mobile tank system including a storage container as illustrated in FIGS. 1-12 above.

FIG. 14 shows a schematic cross-sectional view of a charging/discharging connection according to the present disclosure.

### DETAILED DESCRIPTION OF THE INVENTION

The present invention is based on the basic idea that sorbents loaded with gas, for example hydrogen, are kept in stock in an external system, for example a filling station, and then exchanged for used sorption material in a storage container, for example a mobile tank. In this way, a charging operation, for example filling of a tank, can be drastically shortened. The used or desorbed sorption materials are then loaded again with gas, for example hydrogen, in the external system and no longer, as hitherto customary, in the storage container itself and are available for another charging operation. For this purpose, sorbents configured or selected in a particular way are necessary and are likewise provided by the present invention.

A great advantage of the present invention is also, for example, a complete recycling system in which the unloaded sorbents or sorption materials are replaced by loaded sorbents or sorption materials. A certain percentage of the sorbents can, for example, be replaced from time to time by freshly produced sorbents. Owing to the high abrasion resistance of the sorbents used according to the invention, it can be possible to use a product batch of sorbents for years.

According to the first aspect of the invention, the invention provides a storage container for storing a sorption material, where the storage container is equipped with a pressure vessel, a connecting element to an external supply system, at least one sorption material which at least during operational use of the storage container is accommodated in the latter and a transport duct for charging and/or discharging the storage container with sorption material, where the sorption material comprises a sorbent and an adsorbate, in particular a gaseous fuel, preferably hydrogen, adsorbed thereon. The storage container is, according to the invention, characterized in that firstly at least one second duct for introducing and/or discharging a gas (gas duct) is provided and in that secondly the sorbent is based on high-performance adsorbents based on activated carbon in the form of discrete activated carbon grains, preferably in spherical form, where at least 70% of the total pore volume of the high-performance adsorbents is formed by micropores having pore diameters of ≦20 Å (i.e. in other words highly microporous high-performance adsorbents are used). In a preferred embodiment, the high-performance adsorbents used according to the invention have a total pore volume determined by the Gurvich method of at least 0.7 cm³/g, with at least 70% of this total pore volume being formed by micropores having pore diameters of ≦20 Å.

As the applicants have surprisingly and unexpectedly discovered, a highly microporous activated carbon of the abovementioned type is particularly suitable for the present invention since, firstly, such an activated carbon has an extremely high loading capacity for the relevant fuel gases, in particular hydrogen, and, secondly, such an activated carbon has an optimal adsorption and desorption behavior for the uses according to the invention. In addition, the activated carbon concerned has an extremely high abrasion resistance and thus has excellent wear properties which allows its long-term use, in particular over a number of months or even years, and also makes recycling possible. Owing to the abrasion resistance and freedom from dust of the high-performance adsorbents used according to the invention, contamination of the apparatus components used is avoided in an efficient way and the risk of ignition or explosions is ruled out or else at least largely minimized. Finally, the spherical shape of the sorbents used makes the charging and discharging operation not inconsiderably easier. Further advantages associated with the use of the activated carbon selected according to the invention are indicated below in the detailed characterization of the activated carbon used according to the invention and can be derived by a person skilled in the art from a study of the description, the claims and the figures.

An activated carbon suitable for the purposes of the invention is disclosed, in particular, in the German patent application 10 2006 048 790.7 of Oct. 12, 2006 and the parallel German utility model application 20 2006 016 898.2 of Nov. 4, 2006, whose total respective disclosure content is hereby incorporated by reference, and is also commercially available from Blucher GmbH, Erkrath, and also Adsor-Tech GmbH, Premnitz.

The storage container of the invention is configured so that it can accommodate sorption material on which a gas is adsorbed supplied from the outside. In its operating state, the storage container is charged with sorption material and can supply adsorbed gas, for example hydrogen, as required to a consumer. When the storage container has to be recharged, the used sorption material is removed therefrom and replaced by fresh unexhausted sorption material. In this respect too, the storage container is configured in a particular way. The detailed way in which this can be realized, is explained during the further course of the description with the aid of some advantageous but nonexclusive examples.

Firstly, it is advantageously provided that the storage container has an inner container for accommodating the sorption material which then represents the actual pressure vessel. Furthermore, a second outer container located outside the inner container is advantageously provided and performs, first and foremost, the function of an insulation container. The outer container can also serve to protect the inner container against the damage.

An insulation region is preferably provided between the inner container and the outer container. This insulation region can, for example, be configured as a type of hollow space in which an insulation material can be present. The insulation material can be solid, liquid or gaseous. It is also conceivable for the insulation region to be configured in the form of an insulation layer which can be, for example, a film, mat or the like which is arranged between outer and inner containers.

Some preferred embodiments of the storage container are described below without, however, restricting the invention to these examples.

The objective is a charging and discharging system which is mechanically very simple in order to avoid complicated constructions and moving parts within the storage container. The basic idea is to transport the granular, preferably particulate or spherical sorption material by means of a gas stream at virtually any pressure, in particular up to about 40 bar.

The storage container should have essentially two openings/ducts for media, which will hereinafter be referred to as ducts. A first duct is the transport duct which is first and foremost responsible for the transport of the sorption materials. This duct serves, for example, to transport the sorption material both from the filling station to the tank system and also from the tank system to the filling station. A further duct is formed by a gas duct via which gases are conveyed into the container and conveyed out of the latter. This will be explained in detail in the further course of the description.

The transport duct and/or the gas duct can advantageously be tubular. The invention is not restricted to particular tube cross sections. Rather, these are determined by hydrodynamic requirements. However, a circular or oval cross section is advantageously provided.

The transport duct and/or the gas duct can preferably be configured in the form of a nozzle. This makes it possible to achieve a suitable flow regime within the storage container particularly advantageously.

To avoid undesirable discharge of sorption material from the storage container, at least one filter element for filtering off sorption material and/or sorbent can preferably be provided in the gas duct.

The first duct (transport duct) is advantageously provided with a comparatively large diameter relative to the particle size of the sorption material, for example a diameter of at least 50 times the particle size.

The second duct (gas duct) is advantageously configured in the form of a nozzle and has a filter which retains the sorption material particles which enter. This nozzle serves as gas outlet during charging of the tank system (storage container).

During charging of the tank system with fresh sorption material, this is introduced in a volume stream via the first duct (transport duct) into the tank system. A carrier gas (for example hydrogen carrier gas) required for this purpose leaves the system via the second duct (gas duct). On discharging the tank system, gas, for example hydrogen gas, flows via the second duct configured as a nozzle (gas duct) into the tank system. Due to the high flow velocity out of the outlet and the position of the nozzle in the tank system, sorption material present in the tank system is fluidized and transported from the tank system via the first duct (transport duct) by the gas flow. The tank system can be charged and discharged in this way.

In a further embodiment, the transport duct and the gas duct can be connected to one another in the storage container and form a tube loop. This embodiment makes use of the dynamic pressure drop at places having an increased flow velocity in accordance with the Bernoulli equation

$$\frac{1}{2} ρ {v}^{2} + ρ gh + P = const .$$

(Venturi tube). The tube loop is advantageously a closed tube loop having a very low internal flow resistance.

In the tube loop, it can be advantageous to provide at least one rotatable flap, preferably two flaps, two alter the transport stream within the tube loop.

For example, the tube loop can be interrupted in two places by flow-driven flaps which can be rotated through 90°. The objective of these flaps is diversion of the transport stream (sorption material+carrier gas) during the charging operation. The first flap closes the passage through the tube system and thereby brings about introduction of the sorption material into the storage container. The carrier gas is conveyed via the second flap back into the tube system and can, for example, be returned to the fuel dispenser. On emptying the storage container, the carrier gas flows in the opposite direction through the tube loop. A constriction of the tube loop (cf. the above-described Venturi principle) leads to a reduction in the static pressure in the tube section and thus to sucking of sorption material from the storage container. The sorption material is dispersed in the carrier stream and discharged from the storage container.

A filter upstream of the flap(s) can prevent undesirable discharge of sorption material. At least one filter element for filtering off sorption material and/or sorbent can therefore advantageously be provided in the tube loop, with the filter element preferably being arranged in the region of the rotatable flap(s).

The storage container can advantageously be able, at feast during the charging operation and/or discharging operation, to be brought into or aligned in a slanted position, based on a horizontal or vertical reference plane (depending on whether the storage container is arranged vertically or horizontally). A slightly slanted position of the storage container and advantageous positioning of the Venturi section in the vicinity of the lowest point perform the task of transporting the sorption material to within the reach of the suction effect by utilizing gravity on the slanted plane.

In a further embodiment, it can be provided for the transport duct and the gas duct to be combined in a single duct and for the duct to be configured as accommodation for a charging/discharging connection. This embodiment is used in particular in the context of a charging/discharging connection described in more detail below. An advantage of this embodiment is the decoupling of the components required for charging and discharging from the storage container and thus a substantial saving of weight and heat capacity. The task of introduction and removal of sorption material and carrier gas is performed by a connection which is inserted into the storage container and can also be flexible and which is advantageously characterized in that the length of the connection in the storage container can be adjusted in order to be able to fluidize and discharge the sorption material in very close vicinity.

At least one sensor element for measuring operation-specific properties of the storage container and/or of the sorption material and/or of the sorbent can advantageously be provided. Such measured values can, as explained in more detail below, be used to optimize the charging and discharging operation further.

In such a case, at least one interface for transmitting values measured by the at least one sensor element can advantageously be provided. This can particularly advantageously be a data interface.

Even though the storage container can be used for storing any gaseous media, it can particularly preferably be configured as storage tank for a gaseous fuel, in particular hydrogen.

As indicated above, high-performance adsorbents based on activated carbon having a high microporosity, as are disclosed in the German patent application 10 2006 048 790.7 and the parallel German utility model application 20 2006 016 898.2, both in the name of Bücher GmbH, Erkrath, are preferably used as sorbent for the purposes of the present invention.

Such high-performance adsorbents based on activated carbon in the form of discrete activated carbon grains, preferably in spherical form, are characterized by a high microporosity, with generally at least 70% of the total pore volume of the high-performance adsorbents used according to the invention being formed by micropores having a pore diameter of ≦20 Å. In a preferred embodiment of the present invention, the high-performance adsorbents used according to the invention have a total pore volume determined by the Gurvich method of at least 0.7 cm³/g, with at least 70% of this total pore volume being formed by micropores having pore diameters of ≦20 Å.

In addition, the activated carbon-based high-performance adsorbents of the abovementioned type used as sorbents for the purposes of the present invention have an average pore diameter of not more than 30 Å and/or a BET surface area of at least 1 500 m²/g.

The high-performance adsorbents based on activated carbon in the form of discrete activated carbon grains, preferably in spherical form, which are used as sorbents for the purposes of the present invention are thus characterized, in particular, by the following parameters:
a proportion of micropores having pore diameters of ≦20 Å of at least 70% of the total pore volume, particularly preferably a total pore volume determined by the Gurvich method of at least 0.7 cm³/g, with at least 70% of this total pore volume being formed by micropores having pore diameters of ≦20 Å, and/or
an average pore diameter of not more than 30 Å and/or
a BET surface area of at least 1 500 m²/g.

The high-performance adsorbents or activated carbons used according to the invention are characterized, in particular, by a high total porosity and a simultaneously large BET surface area. As indicated again below, the mechanical strength, in particular the abrasion resistance and the rupture or compressive strength, of the high-performance adsorbents used according to the invention is, in contrast to comparable high-porosity activated carbons of the prior art, extremely high despite the high porosity, so that the high-performance adsorbents or activated carbons used according to the invention are also suitable for applications in which they are subjected to high mechanical stresses.

In the case of all parameter values indicated above and in the following, it should be noted that the limit values given, in particular upper and lower limits, are also encompassed, i.e. all values are to be interpreted as including the respective limits. Furthermore, it goes without saying that it may in individual cases or for particular applications be necessary to deviate from the limit values mentioned without going outside the scope of the present invention.

The parameter values mentioned above and in the following for the high-performance adsorbents used according to the invention are determined by standardized or explicitly described methods of determination or methods of determination which are known per se to a person skilled in the art. The parameter values concerning the characterization of the porosity are in each case obtained from the nitrogen isotherms of the activated carbon measured.

As regards the determination of the total pore volume by the Gurvich method, this is a measurement/determination method known per se to a person skilled in this field. For further details regarding the determination of the total pore volume by the Gurvich method, reference may be made, for example, to L. Gurvich (1915), J. Phys. Chem. Soc. Russ. 47, 805, and to S. Lowell et al., Characterization of Porous Solids and Powders: Surface Area Pore Size and Density, Kluwer Academic Publishers, Article Technology Series, pages 111 ff.

The determination of the specific surface area by the BET method is basically known per se to a person skilled in the art, so that no further details have to be given in this respect. All BET surface area figures are based on the determination in accordance with ASTM D6556-04. For the purposes of the present invention, the multipoint BET determination method (MP-BET) in a partial pressure range p/p₀ of from 0.05 to 0.1 is employed for determining the BET surface area. For further details on the determination of the BET surface area or on the BET method, reference may be made to the abovementioned ASTM D6556-04 and to Römpp Chemielexikon, 10th edition, Georg Thieme Verlag, Stuttgart/New York, keyword: “BET-Methode”, including the references cited therein, and to Winnacker-Küchler (3rd edition), Volume 7, pages 93 ff. and to Z. Anal. Chem. 238, pages 187 to 193 (1968).

The determination of the average pore diameter is carried out on the basis of the respective nitrogen isotherms.

The total pore volume determined by the Gurvich method of the high-performance adsorbents used according to the invention is at least 0.7 cm³/g, in particular at least 0.8 cm³/g, preferably at least 0.9 cm³/g, particularly preferably at least 1.0 cm³/g, and can reach values of up to 1.5 cm³/g, in particular up to 1.6 cm³/g, preferably up to 1.8 cm³/g. In general, the total pore volume determined by the Gurvich method of the high-performance adsorbents used according to the invention is in the range from 0.7 to 1.8 cm³/g, in particular from 0.8 to 1.6 cm³/g, preferably from 0.9 to 1.5 cm³/g.

A particular property of the high-performance adsorbents used according to the invention is, inter alia, that they have a very large total pore volume determined by the Gurvich method, so that a large adsorption capacity is made available, with a high proportion being due to micropores.

In general, at least 70%, in particular at least 75%, preferably at least 80%, particularly preferably at least 85%, very particularly preferably at least 90%, of the total pore volume, in particular the total pore volume determined by the Gurvich method, of the high-performance adsorbents used according to the invention is formed by micropores having pore diameters of ≦20 Å. In general, from 70% to 95%, in particular from 75% to 90%, preferably from 75% to 85%, of the total pore volume, in particular the total pore volume determined by the Gurvich method, of the high-performance adsorbents used according to the invention is formed by micropores having pore diameters of ≦20 Å (for the purposes of the present invention, the term micropores refers to pores having pore diameters up to 20 Å inclusive, while the term mesopores refers to pores having pore diameters of from >20 Å to 50 Å inclusive and the term macropores refers to pores having pore diameters of >50 Å).

Owing to their high microporosity, the micropore volume of the high-performance adsorbents used according to the invention is relatively high: in general, the micropore volume formed by micropores having pore diameters of ≦20 Å determined by the carbon black method of the high-performance adsorbents used according to the invention is in the range from 0.5 to 1.4 cm³/g, in particular from 0.6 to 1.2 cm³/g, preferably from 0.7 to 1.1 cm³/g. The determination method for carbon black is known per se to those skilled in the art, so that no further details are required on the subject. In addition, for further details regarding the determination of the pore surface area and the pore volume by the carbon black method, reference may be made, for example, to R. W. Magee, Evaluation of the External Surface Area of Carbon Black by Nitrogen Adsorption, Presented at the Meeting of the Rubber Division of the American Chem. Soc., October 1994, e.g. referred to in: Quantachrome Instruments, AUTOSORB-1, AS1 WinVersion 1.50, Operating Manual, OM, 05061, Quantachrome Instruments 2004, Florida, USA, pages 71 ff.

Owing to the high microporosity of the high-performance adsorbents used according to the invention, their average pore diameter is relatively small: in general, it is not more than 30 Å, in particular not more than 26 Å, preferably not more than 25 Å, very particularly preferably not more than 24 Å. In general, the average pore diameter of the high-performance adsorbents used according to the invention is in the range from 15 to 30 Å, in particular from 16 to 26 Å, preferably from 17 to 25 Å, particularly preferably from 18 to 24 Å.

As indicated above, a particular property of the high-performance adsorbents used according to the invention is the relatively high BET surface area which is at least 1 500 m²/g, preferably at least 1 525 m²/g, particularly preferably at least 1 550 m²/g, very particularly preferably at least 1 575 m²/g. In general, the BET surface area of the high-performance adsorbents used according to the invention is in the range from 1 500 m²/g to 3 500 m²/g, in particular from 1 500 m²/g to 2 750 m²/g, preferably from 1 525 to 2 500 m²/g, particularly preferably from 1 550 to 2 400 m²/g, very particularly preferably from 1 575 to 2 350 m²/g.

The weight- and volume-based volume V_{ads} (N₂) of the high-performance adsorbents used according to the invention at various partial pressures p/p₀ is also very high:

Thus, the weight-based adsorbed N₂ volume V_{ads (wt.)} of the high-performance adsorbents used according to the invention, determined at a partial pressure p/p₀ of 0.25, is at least 400 cm³/g, in particular at least 420 cm³/g, and is in particular in the range from 400 to 800 cm³/g, preferably from 410 to 750 cm³/g, particularly preferably from 420 to 700 cm³/g. Furthermore, the weight-based adsorbed N₂ volume V_{ads (wt.)} of the high-performance adsorbents used according to the invention, determined at a partial pressure p/p₀ of 0.995, is at least 450 cm³/g, in particular at least 460 cm³/g, and is in particular in the range from 450 to 900 cm³/g, preferably from 460 to 875 cm³/g, particularly preferably from 470 to 850 cm³/g.

In general, the volume-based adsorbed N₂ volume V_{ads (vol.)} of the high-performance adsorbents used according to the invention, determined at a partial pressure p/p₀ of 0.25, is at least 200 cm³/cm³, in particular at least 220 cm³/cm³, and is in particular in the range from 200 to 300 cm³/cm³, preferably from 210 to 275 cm³/cm³, particularly preferably from 225 to 260 cm³/cm³. Furthermore, the volume-based adsorbed N₂ volume V_{ads (vol.)} of the high-performance adsorbents used according to the invention, determined at a partial pressure p/p₀ of 0.995, is at least 250 cm³/cm³, in particular at least 260 cm³/cm³, and is in particular in the range from 250 to 400 cm³/cm³, preferably from 260 to 350 cm³/cm³, particularly preferably from 265 to 320 cm³/cm³.

A further particular property of the high-performance adsorbents used according to the invention is the high micropore surface area, i.e. the high surface area formed by pores having pore diameters of ≦20 Å. In general, the micropore surface area formed by pores having pore diameters of ≦20 Å determined by the carbon black method of the high-performance adsorbents used according to the invention is at least 1 400 m²/g, in particular at least 1 450 m²/g, preferably at least 1 500 m²/g, and is generally in the range from 1 400 to 2 500 m²/g, in particular from 1 450 to 2 400 m²/g, preferably from 1 500 to 2 300 m²/g.

In addition, the high-performance adsorbents used according to the invention have an extremely high butane adsorption and at the same time an extremely high iodine number, which characterizes their excellent adsorption properties in respect of a wide variety of substances to be adsorbed. Thus, the butane adsorption of the high-performance adsorbents used according to the invention determined in accordance with ASTM D5742-95/00 is generally at least 25%, in particular at least 30%, preferably at least 40%; in general, the high-performance adsorbents used according to the invention have a butane adsorption determined in accordance with ASTM D5742-95/00 in the range from 25% to 80%, in particular from 30% to 70%, preferably from 35 to 65%. The iodine number of the high-performance adsorbents used according to the invention determined in accordance with ASTM D4607-94/99 is generally at least 1 350 mg/g, in particular at least 1 450 mg/g, preferably at least 1 500 mg/g; the high-performance adsorbents used according to the invention preferably have an iodine number determined in accordance with ASTM D4607-94/99 in the range from 1 350 to 2 100 mg/g, in particular from 1 450 to 2 050 mg/g, preferably from 1 500 to 2 000 mg/g.

Despite the high porosity, in particular microporosity, the high-performance adsorbents used according to the invention have a high compressive or rupture strength (ability to withstand a weight loading) and also an extremely high abrasion resistance. Thus, the compressive or rupture strength (ability to withstand a weight loading) per activated carbon grain, in particular per activated carbon sphere, is at least 10 newton, in particular at least 15 newton, preferably at least 20 newton. In general, the compressive or rupture strength (ability to withstand a weight loading) per activated carbon grain, in particular per activated carbon sphere, is in the range from 10 to 50 newton, in particular from 12 to 45 newton, preferably from 15 to 40 newton.

As indicated above, the abrasion hardness of the high-performance adsorbents used according to the invention is also extremely high: thus, the abrasion resistance determined by the method published by CEFIC (Conseil Europeén des Fédérations de l'Industrie Chimique, Avenue Louise 250, Bte 71, B-1050 Brussels, November 1986, European Council of Chemical Manufacturers' Federations, Testmethoden für Aktivkohlen, item 1.6 “Mechanical Hardness”, pages 18/19) is always 100%. In accordance with ASTM D3802 too, abrasion resistances of the high-performance adsorbents used according to the invention of 100% are always obtained. A modified test method based on this CEFIC method was therefore developed to obtain more informative values. The modified method of determination better simulates the resistance of the sample or the high-performance adsorbents to abrasion or crushing under conditions close to industrial practice. For this purpose, the sample is stressed in a horizontally oscillating milling cylinder charged with a tungsten carbide ball under standardized conditions. For this purpose, the following procedure was employed: 200 g of a sample are dried at (120±2)° C. in a convection drying oven (model: Heraeus UT 6060 from Kendro GmbH, Hanau) for one hour and subsequently cooled to room temperature over desiccants in a desiccator. 50 g of the dried sample are taken and sieved through an analytical sieve (analytical sieve having a mesh opening of 0.315 mm, diameter: 200 mm, height: 50 mm) by means of a sieving machine with analytical sieve (model: AS 200 control from Retsch GmbH, Hanau) at a vibration height of 1.2 mm for ten minutes; the undersize is discarded. 5 ml of the nominal particle fraction are introduced into a 10 ml measuring cylinder in accordance with DIN ISO 384 (volume: 10 ml, height: 90 mm) and the weight is determined in a weighing bottle having a ground-glass lid (volume: 15 ml, diameter: 35 mm, height: 30 mm) to within 0.1 mg by means of an analytical balance (model: BP121S from Sartorius AG, Göttingen, weighing range: 120 g, accuracy class: E2, readability: 0.1 mg). The weighed sample is placed together with a tungsten carbide milling ball having a diameter of 20 mm in a 25 ml milling cylinder having a screw closure (volume: 25 ml, diameter: 30 mm, length: 65 mm, material: stainless steel) and the abrasion test is then carried out by means of a vibratory mill (model: MM301 from Retsch GmbH, Haan, vibratory mill with milling cylinder); here, the milling cylinder oscillates horizontally for one minute at a frequency of 10 Hz in the vibratory mill, which leads to the milling ball hitting the sample, resulting in abrasion. The sample is subsequently sieved on the abovementioned analytical sieve by means of a sieving machine having a vibration height of 1.2 mm for five minutes, with the undersize again being discarded and the nominal particle fraction larger than 0.315 mm being reweighed to within 0.1 mg in the weighing bottle with lid. The abrasion hardness is calculated as proportion by mass in % according to the following formula: abrasion hardness [%]=(100×weight on reweighing [g])/initial weight [g]. According to this modified method of determination based on the abovementioned CEFIC standard, the abrasion resistance of the high-performance adsorbents used according to the invention is at least 95%, in particular at least 96%, preferably at least 97%, particularly preferably at least 98%, very particularly preferably at least 99%.

The high-performance adsorbents used according to the invention are based on particulate, particularly spherical, activated carbon whose average particle diameter, determined in accordance with ASTM D2862-97/04, is in the range from 0.01 to 1.0 mm, in particular from 0.1 to 0.8 mm, preferably from 0.2 to 0.7 mm, particularly preferably from 0.4 to 0.55 mm.

The ash content of the high-performance adsorbents used according to the invention, determined in accordance with ASTM D2866-94/04, is not more than 1%, in particular not more than 0.8%, preferably not more than 0.6%, particularly preferably not more than 0.5%.

The moisture content of the high-performance adsorbents used according to the invention determined in accordance with ASTM D2867-04/04 is not more than 1%, in particular not more than 0.5%, preferably not more than 0.2%.

The high-performance adsorbents used according to the invention generally have a bulk density, determined in accordance with ASTM B527-93/00, in the range from 250 to 750 g/l, in particular from 300 to 700 g/l, preferably from 300 to 650 g/l, particularly preferably from 350 to 600 g/l.

As regards the external pore volume determined by the carbon black method of the high-performance adsorbents used according to the invention, this is generally in the range from 0.05 to 0.5 cm³/g, in particular from 0.1 to 0.45 cm³/g. In general, the external pore volume determined by the carbon black method of the high-performance adsorbents used according to the invention forms not more than 35%, preferably not more than 30%, of the total pore volume, in particular from 10% to 35%, preferably from 14 to 30%, of the total pore volume.

As regards the external pore surface area determined by the carbon black method of the high-performance adsorbents used according to the invention, this is generally in the range from 50 to 300 m²/g, in particular from 60 to 250 m²/g, preferably from 70 to 200 m²/g. In general, the external pore surface area determined by the carbon black method of the high-performance adsorbents used according to the invention is not more than 15%, preferably not more than 10%, of the total pore surface area, in particular from 4% to 15%, preferably from 4 to 12%, of the total pore surface area.

As regards the production of the high-performance adsorbents used according to the invention, these can be obtained by carbonization and subsequent activation of gel-like sulfonated styrene-divinylbenzene copolymers, in particular sulfonated divinylbenzene-crosslinked polystyrenes, in granular form, preferably in spherical form. The divinylbenzene content of the sulfonated styrene-divinylbenzene copolymers used as starting materials for producing the high-performance adsorbents according to the invention should be, in particular, in the range from 1 to 15% by weight, preferably from 2 to 10% by weight, based on the styrene-divinylbenzene copolymers. The starting polymers have to be of the gel type so that a microporous structure can be formed. If unsulfonated starting materials are used, the sulfonation can be carried out in situ, in particular by methods which are known per se to those skilled in the art, preferably by means of sulfuric acid and/or oleum. A person skilled in the art will be familiar with this in principle. Starting materials which have been found to be particularly useful are gel-like grades of the corresponding ion exchange resins or the corresponding precursors of ion exchange resins which still have to be sulfonated. In the carbonization (also referred to synonymously as pyrolysis, burning or low-temperature calcination), the carbon-containing starting polymers are converted into carbon, i.e., in other words, the carbon-containing starting material is carbonized. In the carbonization of the abovementioned, gel-like organic polymer grains, in particular polymer spheres, which are based on styrene and divinylbenzene and contain sulfonic acid groups, the elimination of the sulfonic acid groups during carbonization leads to free radicals and thus to crosslinks without which there would be no pyrolysis residue (=carbon). In general, the carbonization is carried out under an inert atmosphere (e.g. nitrogen) or an at most slightly oxidizing atmosphere. It can likewise be advantageous to add a small amount of oxygen, in particular in the form of air (e.g. from 1 to 5%) to the inert atmosphere during the carbonization, in particular at high temperatures (e.g. in the range from about 500 to 650° C.) in order to effect oxidation of the carbonized polymer backbone and in this way aid the subsequent activation. In general, the carbonization is carried out at temperatures of from 100 to 950° C., in particular from 150 to 900° C., preferably from 300 to 850° C. The total duration of the carbonization is from about 30 minutes to 6 hours. After the carbonization, the carbonized intermediate is subjected to activation, at the end of which the high-performance adsorbents based on activated carbon which are used according to the invention are obtained in granular form, in particular spherical form. The basic principle of the activation is to remove part of the carbon generated in the carbonization selectively and in a targeted manner under suitable conditions. This produces numerous pores, crevices and cracks and the surface area per unit mass increases considerably. Thus, a targeted burning of the carbon is carried out during activation. Since carbon is removed during the activation, a loss of material occurs in this process, which is, under optimal conditions, equivalent to an increase in the porosity and an increase in the internal surface area and the pore volume. The activation is therefore carried out under selective and controlled oxidizing conditions. The activation is generally carried out at temperatures of from 700 to 1300° C., in particular from 800 to 1200° C., preferably from 900 to 1100° C.

Apart from the choice of the above-described starting material, a special aspect of the production of the high-performance adsorbents used according to the invention is the specific way in which the activation is carried out, in particular in the duration of the activation in combination with the activation atmosphere selected. It is surprising that when the activation is carried out for an extremely long time, in particular from 12 to 30 hours, preferably from 19 to 23 hours, using an only weakly oxidizing atmosphere which contains only small amounts of water vapor of only from about 0.1 to 5% by volume, in particular from 0.5 to 4% by volume, in an otherwise nitrogen-containing atmosphere and starting out from the selected starting materials, the high-performance adsorbents used according to the invention which have a high microporosity and a high mechanical stability together with the other above-described properties result. In particular, it is surprising that, firstly, the extremely long activation time does not lead to damaging, excessive burning with considerable loss of material and, secondly, an extremely high abrasion resistance and mechanical compressive strength is obtained despite the high porosity with a simultaneously high microporosity. It would not have been expected that such long activation times would not lead to a disadvantageous result and the microporosity or the micropore volume is generated largely selectively at such long activation times as long as the gel-like starting materials as defined above are used. The microporosity can be set in a targeted manner by varying the activation times, in particular in the range from 12 to 30 hours, preferably from 19 to 23 hours. In this way, the high-performance adsorbents used according to the invention can be, so to say, tailored.

For example, high-performance adsorbents which can be used according to the invention can be produced as follows: commercial ion exchanger grades of the gel type based on divinylbenzene-crosslinked polystyrene copolymers having a divinylbenzene content of about 4% are firstly predried to remove the proportion of about 50% of water and subsequently sulfonated in a manner known per se using a sulfuric acid/oleum mixture at temperatures of from 100° C. to 150° C. The resulting material is then carbonized in a manner known per se at temperatures of up to 950° C. for 4 hours under a nitrogen atmosphere and subsequently activated by adding small amounts of water vapor (about 1 to 3% by volume) to the nitrogen atmosphere; the introduction of water vapor is maintained in order to regulate the proportion of water vapor in this way. The activation is carried out for 19 hours (“activated carbon I”) or 23 hours (“activated carbon II”). After cooling to room temperature, sorbents which can be used according to the invention are obtained. The parameters for the activated carbons produced in this way (“activated carbon I” and “activated carbon II”) are shown in table 1.

For further details regarding the high-performance adsorbents which can be used according to the invention, reference may be made to the full contents of the German patent application 10 2006 048 790.7 and the parallel German utility model application 20 2006 016 898.2.

TABLE I
Comparison of physicochemical parameters of two high-performance
adsorbents which are based on spherical activated carbon and
can be used according to the invention and commercial microporous
activated carbon in the spherical form from Kureha

| | Acti- | Acti- | Commercial |
|---|---|---|---|
| | vated | vated | activated |
| | carbon | carbon | carbon |
| | I | II | from Kureha |
| Total pore volume (Gurvich) | 0.7336 | 1.3550 | 0.5891 |
| (p/p₀ = 0.995) [cm³/g] ** | | | |
| Average pore diameter [Å] | 18.57 | 24.67 | 17.89 |
| BET (multipoint, MP) | 1580 | 2197 | 1317 |
| (p/p₀ = 0.05-0.1) | | | |
| (ASTM D6556-04) [m²/g] ** | | | |
| Micropore volume | 0.6276 | 0.9673 | 0.5240 |
| (carbon black) [cm³/g] * | | | |
| Proportion of micropores | 85.55 | 71.39 | 88.95 |
| in the total pore volume [%] * | | | |
| Adsorbed volume of N₂ | 423 | 650 | 349 |
| (p/p₀ = 0.25) | | | |
| per unit weight [cm³/g] ** | | | |
| Adsorbed volume of N₂ | 236 | 235 | 206 |
| (p/p₀ = 0.25) | | | |
| per unit volume [cm³/cm³] ** | | | |
| Adsorbed volume of N₂ | 473 | 770 | 380 |
| (p/p₀ = 0.995) | | | |
| per unit weight [cm³/g] ** | | | |
| Adsorbed volume of N₂ | 264 | 279 | 224 |
| (p/p₀ = 0.995) | | | |
| per unit volume [cm³/cm³] ** | | | |
| Micropore surface area | 1509 | 1995 | 1271 |
| (carbon black) [cm³/g] * | | | |
| External pore volume | 0.11 | 0.39 | 0.07 |
| (carbon black) [cm³/g] | | | |
| Proportion of external | 14.4 | 28.6 | 11.1 |
| pore volume in the | | | |
| total pore volume [%] | | | |
| External pore surface area | 71 | 202 | 46 |
| (carbon black) [cm²/g] | | | |
| Proportion of the external | 4.5 | 9.2 | 3.5 |
| pore surface area | | | |
| by BET surface area (MP) [%] | | | |
| Adsorbate | N₂ | N₂ | N₂ |
| Butane adsorption | 33.5 | 59.6 | 29.2 |
| (ASTM D542-95/00) [%] | | | |
| Iodine number | 1470 | 1840 | 1343 |
| (ASTM D4607-94/99) [mg/g] | | | |
| Compressive or rupture strength | 3.75 | 1.4 | 0.45 |
| (ability to withstand weight | | | |
| loading) [kg/active carbon | | | |
| sphere] | | | |
| Average diameter | 0.52 | 0.44 | 0.44 |
| (ASTM D2866-94/04) [mm] | | | |
| Ash content | 0.50 | 0.45 | 0.04 |
| (ASTM D2866-94/04) [%] | | | |
| Moisture content | 0.04 | 0.1 | 0.37 |
| (ASTM D2867-04/04) [%] | | | |

* Micropores: pores having pore diameters of ≦20 Å
** p/p₀ = partial pressure or partial pressure range

As the applicants have surprisingly and unexpectedly found, the above-mentioned sorbents based on the above-described microporous activated carbon-based high-performance adsorbents used according to the present invention, in particular when used in the storage container of the invention, when employed for gaseous fuels, in particular hydrogen, give the best values in respect of storage of the gaseous fuels, in particular hydrogen, compared to commercial microporous activated carbon and also activated carbon having a relatively low microporosity. Thus, at 20 bar and 77 K, at least 30 g of hydrogen per kg of activated carbon, in particular at 35 g of hydrogen per kg of activated carbon, preferably at least 40 g of hydrogen per kg of activated carbon, particularly preferably at least 70 g of hydrogen per kg of activated carbon, can be stored purely adsorptively by means of the activated carbon-based microporous high-performance adsorbents of the above-described type which are used according to the invention; this is added to by nonadsorptive storage capacity, in particular as a result of storage of gaseous hydrogen in interstices, voids, cavities, macropores and mesopores or the like, which is, in addition to the adsorptive storage capacity, at least 5 g of hydrogen per kg of activated carbon, in particular at least 10 g of hydrogen per kg of activated carbon, preferably at least 15 g of hydrogen per kg of activated carbon, particularly preferably at least 30 g of hydrogen per kg of activated carbon, so that a total storage capacity in respect of hydrogen at 20 bar and 77 K for the activated carbon-based microporous high-performance adsorbents of the above-described type which are used according to the invention of at least 35 g of hydrogen per kg of activated carbon, in particular at least 40 g of hydrogen per kg of activated carbon, preferably at least 45 g of hydrogen per kg of activated carbon, particularly preferably at least 50 g of hydrogen per kg of activated carbon, very particularly preferably at least 55 g of hydrogen per kg of activated carbon, even more preferably at least 100 g of hydrogen per kg of activated carbon, results (these storage amounts can be controlled in a targeted manner by adjustment of pressure and/or temperature.). As studies by the applicants have shown, the analogous storage capacities of commercial microporous activated carbon and of activated carbon having a relatively low microporosity (proportion by volume of micropores <70%), in particular of mesoporous and/or macroporous activated carbon, is in comparison at least 20%-30% below the abovementioned values. As the applicants have surprisingly discovered, an optimal storage capacity is thus achieved only by means of the above-described microporous activated carbon-based high-performance adsorbents.

A further, second aspect of the invention provides a tank system, in particular a mobile tank system, which is configured to provide a gaseous fuel for a drive apparatus. The tank system is characterized in that it has at least one storage container of the type described above. What has been said above with regard to the storage container is therefore fully incorporated by reference.

The storage container can advantageously be connected via a duct, preferably the transport duct and/or the gas duct, to a heat exchange apparatus.

The tank system can also have at least one interface for transmitting values measured by at least one sensor element for measuring operation-specific properties of the storage container and/or the sorption material and/or the sorbent, advantageously a data interface.

The structure and the mode of operation of the tank system are illustrated below with the aid of an example in which the stored gas is hydrogen. What is said below naturally also applies to other types of gas.

There are a number of options for taking hydrogen from the mobile tank system. The amount of hydrogen stored in the mobile tank system is made up of the adsorbed phase (H_{ads}), i.e. the hydrogen adsorbed on the sorbent, and the gas phase (H_{gas}), i.e. the hydrogen gas present in the free volume of the tank. For any state (temperature and pressure), an equilibrium dependent on the adsorption properties of the sorption material is established. Immediately after filling of the tank, for example of a vehicle (pressure in the tank system: 40 bar; temperature 77 K), the hydrogen required by the drive unit of the vehicle can be taken directly from the gas phase. This hydrogen is available virtually immediately in an amount determined by the pressure prevailing in the tank system. The removal of hydrogen from the gas phase disturbs the equilibrium between adsorbed phase and gas phase in the tank. As the pressure drops, only part of the adsorbed hydrogen is desorbed in order to partially make up the loss in the gas phase. However, the decreasing temperature caused by desorption slows down the desorption process. When hydrogen is briefly taken from the gas phase of the mobile tank system, the pressure drops, for example, from 40 bar to 38 bar, with the temperature dropping from, for example, 77 K to 65 K because of the negligible heat flow from the surroundings through the insulation (the size of the decrease is ultimately dependent on the adsorption enthalpies and properties of the sorbent). The hydrogen is thus continually taken from the gas phase in order to supply the drive unit of the vehicle. However, as soon as the pressure in the tank system drops below the pressure required by the consuming device, the volume flow of hydrogen required by the drive unit of the vehicle can no longer be maintained (for example: pressure=2 bar) (values dependent on sorbent and consuming device).

The supply of hydrogen can be ensured by an attached pump (disadvantage: consumer of electricity!) or preferably by means of a targeted increase in the temperature in the tank system.

This can advantageously be achieved by cold hydrogen which has already been taken off and being heated by means of a heat exchanger which preferably uses heat from the surroundings and returned to the tank system where the heat capacity stored in the gas is transferred to the sorbent (recycling). The heat input can be controlled by means of suitable valves, for example by means of two magnetic valves which are positioned on the tank system and interrupt the line in order to avoid undesirable input of heat, for example when the vehicle is not being utilized.

The recycling system presented enables the temperature in the tank system to be increased without use of electric heating and the hydrogen present in the adsorbed phase thus also to be desorbed and utilized when required.

For further details on the subject, reference may also be made to WO 2005/044452 A2 and DE 20 2004 017 036 U1.

A further, third aspect provides a charging/discharging connection for charging and/or discharging a storage container, in particular a storage container as described above, having a first duct for conveying a sorption material, in particular a sorption material as described above, which can be connected to a transport duct of a storage container and having a second duct, in particular for conveying a gas, which can be connected to a gas duct of a storage container.

The task of introducing and removing sorption material and carrier gas is performed by the connection which is characterized in that the length of the connection in the storage container can be adjusted in order to be able to fluidize and discharge the sorption material in very close vicinity. The adjustable, spatial proximity of the discharge duct to the sorption material also makes it possible to integrate a suction action into the discharge process so that the recirculation of gas, for example hydrogen, is not absolutely necessary for emptying the storage container. It has advantageously been possible, for example, to use the above-described Bernoulli principle, but outside the storage container, to discharge the material.

The connection firstly has a duct (transport duct) for particles of the sorption material which are transported by a gas stream. The duct preferably has a round cross section, with the diameter advantageously corresponding to many times the size of the particles to be transported.

Furthermore, a second duct (gas duct) for gas is provided. This duct is intended only for gas transport and is advantageously protected by means of filters against intrusion of particles of the sorption material.

As an alternative, both ducts can be suitable for the transport of sorption material. In this way, cooled transport medium can always be transported by means of one of the two ducts, preferably an insulated duct, during charging and discharging of the storage container. This can avoid losses which occur when using a warm duct for a cold medium (medium is warmed/sorption material desorbs gas on warming).

For example, the first duct and/or the second duct can be thermally insulated. This can prevent introduction of heat into the cold gases and the cold sorption material (preferably 77 K).

The first duct and the second duct can preferably be arranged next to one another with a spacing between them. In a further embodiment, the first duct and the second duct can be arranged concentrically. The feed duct and the discharge duct are thus arranged concentrically within or around one another.

The connection can be flexible at least in regions in its end region which can be brought onto contact with a storage container or can be inserted in the latter. This further simplifies charging and discharging.

The connection can preferably have an interface for receiving data and/or transmitting data. Preference is here given to a data connection, in particular an electric data connection, which allows information exchange between the system described below, for example a filling station, and the storage container, for example in a tank system of a vehicle, or the vehicle itself. Information on, for example, the type of sorption material, the state of loading, pressure, temperature and the like can be transmitted.

A further, fourth aspect of the invention provides a system for providing a sorption material, in particular a sorption material as described above, for a storage container, which is characterized in that a charging apparatus which has a device for discharging exhausted sorption material present in a storage container and a device for charging a storage container with unexhausted sorption material is provided and in that a storage facility for storing sorption material to be supplied to a storage container, which storage facility is connected at least part of the time to the charging apparatus, is provided.

Such a system can preferably be a type of filling station. At this filling station, it is possible to fill, for instance, mobile tank systems which are constituents of a vehicle. The problems described in connection with the prior art can be avoided when the sorbent provided for gas storage is loaded with the adsorbate (for example hydrogen) outside the tank system, preferably at a filling station. The heat of sorption evolved here can be removed without time pressure and at lower cost and with lower consumption of energy.

The charging apparatus of this system can advantageously be configured for charging a storage container with sorption material at a pressure above ambient pressure, for example at a pressure of greater than/equal to 40 bar, for example 40 bar.

Furthermore, the charging apparatus of the system can have a charging/discharging connection as described above so that what has been said above in this respect is fully incorporated by reference.

In a further embodiment, the system can have at least one interface for receiving data and/or transmitting data, as has already been mentioned above, particularly preferably a data interface.

The system can advantageously have a facility for monitoring the quality of sorption material discharged from a storage container. Retained, fully loaded sorbent or only partially unloaded sorbent or only partly unloaded sorption material could firstly be assessed by means of quality control and damaged or unusable particles could possibly be sorted out.

In a further embodiment, the system can have a facility for regenerating sorption material discharged from a storage container. The fully unloaded sorbent or the partly unloaded sorption material could be regenerated (heat-treated/baked) in order to remove gaseous impurities, for example from secondary constituents of the gas used. Regular regeneration thus allows, for example, the use of hydrogen having a lower quality/purity (for example purity class 3.0 instead of class 5.0) without significant disadvantages.

The system preferably has a facility for loading a sorbent, in particular a sorbent as described above, and/or a sorption material, in particular a sorption material as described above, with a gas, preferably with hydrogen. This loading facility can have various components.

For example, the loading facility can have a cooling device for cooling the sorbent and/or the sorption material to a predetermined temperature. The sorbent or sorption material can be cooled (77 K) and loaded fresh with hydrogen and made available again, for example at a fuel dispenser.

In a further embodiment, the loading facility can have a device for setting a predetermined loading pressure. It is favorable in energy terms to cool and load the sorbent or sorption material gradually in discrete processes or continuously. A series of temperature steps could be, for example, 0° C./−40° C./−80° C./−120° C./−160° C./−196° C. Coupling of the temperatures to known phase transitions, for example CO_{2solid}→CO_{2gas} (sublimation), may also be useful. Variation of the loading pressure can also, depending on the adsorption behavior of the materials, help to save energy.

Another possibility is to cool and load retained, partly unloaded sorption material or completely unloaded sorbent without quality control or regeneration in order to make it available again, for example at a fuel dispenser. If appropriate, a readable and writeable chip integrated in the tank system can ensure that quality control is carried out independently of the state of loading in an appropriate cycle (for example at each fifth tank filling operation).

Various process aspects which describe how a sorption material can be provided and how a storage container can be charged with such a material are presented below.

Firstly, a method of providing a sorption material for a storage container, in particular by means of a system as described above, which is characterized in that exhausted sorption material present in a storage container is discharged from the storage container, in that the sorption material or sorbent is loaded again with a gas, in particular with hydrogen, outside the storage container and in that the loaded sorption material is subsequently made available again for a storage container, is provided.

As regards the way in which the method functions, what has been said above in respect of the other aspects of the invention is likewise fully incorporated by reference.

The sorption material loaded with gas is advantageously temporarily stored in a storage facility until it is used further. This storage facility can in the case of a filling station be constituent of an appropriately configured fuel dispenser or else be at least connected to the latter.

The exhausted sorption material discharged from the storage facility is advantageously subjected to quality control before being loaded again with a gas. This has been explained above in connection with the system of the invention, so that reference is made to the corresponding statements.

In a further embodiment, the exhausted sorption material discharged from the storage facility can be subjected to a regeneration process before being loaded again with a gas. This has also been explained above in connection with the system of the invention, so that reference is made to the corresponding statements.

The sorption material can advantageously be cooled to a predetermined temperature before being loaded again with gas. This has likewise been explained above in connection with the system of the invention, so that reference is made to the corresponding statements.

A further aspect of the invention provides a method of charging a storage container, in particular a storage container as described above, with a sorption material, in particular a sorption material as described above, which is characterized in that exhausted sorption material present in a storage container is firstly discharged from the storage container and in that the storage container is subsequently charged with unexhausted sorption material.

As regards the way in which the method functions, what has been said above in respect of the other aspects of the invention is likewise fully incorporated by reference.

Such a charging operation, for instance a tank filling operation, requires good transport properties and safe handling of the sorption materials from the storage container of the system, for example the filling station, via a conveying system into the mobile tank. This is not readily possible, for example, when using conventional activated carbon powders since the particle size of the powder varies greatly. The problems resulting therefrom would be separation of the particles during transport (for example only small particles are transported in the gas stream to the mobile tank), partial agglomeration and severe wear of the fittings employed, e.g. pressure reducers, valves and pumps, due to deposition of particles of various dimensions. The use of the sorbents and sorption materials used according to the invention can make the charging operation significantly easier to carry out.

The discharging and charging of the storage container is advantageously carried out by means of a system as described above, so that the corresponding statements are fully incorporated by reference.

The storage container can advantageously be charged with a sorption material which has been provided by means of a method as described above, so that the corresponding statements are fully incorporated by reference.

Before discharging exhausted sorption material from the storage container, the residual amount of adsorbate adsorbed on sorption material remaining in the container and/or unabsorbed, gaseous fuel, in particular hydrogen, is determined. For example, determination of the residual amount of stored gas, for instance hydrogen, can be carried out by measuring the pressure and temperature of the storage medium.

Discharging of exhausted sorption material from the storage container can advantageously be carried out by blowing in gas or fuel used in relation to the sorption material, in particular hydrogen. Discharging of the sorption material or sorbent present in the storage container is effected, for example, by blowing in hydrogen. The specific shape and position of the gas duct, for example in the form of a nozzle, enables the sorption material or sorbent to be fluidized and discharged with the gas stream through the outlet. The pressure of this discharging circuit does not necessarily have to be 40 bar, but can, for example, be matched to the residual pressure in the storage container in order to prevent adsorption or further desorption on/from the sorption material during the discharging process.

The storage container can advantageously be brought to a predetermined temperature between discharging and renewed charging, in particular be cooled. After removal of an advantageous proportion of the sorption material or sorbent (for example about 98%), the storage container (i.e. the empty pressure vessel) is cooled by blowing in gas, for instance cold (77 K) hydrogen. Here, cold (77 K) gas (hydrogen gas) is blown at an appropriate flow velocity and volume flow from the supply system through the duct provided for introduction of gas into the storage container, with heat being removed by the heat flow dQ/dt from the pressure vessel to the cold gas (hydrogen gas) and being transported out of the storage container by discharge of the now wane gas (hydrogen gas) through the duct provided for this purpose.

The renewed charging of the storage container with unexhausted sorption material can preferably be carried out an elevated pressure of greater than/equal to 40 bar.

The unexhausted sorption material is advantageously transported to the storage container and introduced into the latter at a pressure above ambient pressure, preferably at a pressure of greater than/equal to 40 bar, for example at a pressure of 40 bar. Thus, fresh, fully loaded, for example with hydrogen, sorption material is blown in at, for example, 40 or 100 bar pressure via the duct provided for charging. This sorption material has advantageously been precooled to 77 K in the supply system and loaded with gas (hydrogen) at 40 bar. Transport of the sorption material from the supply system to the storage container of the tank system is therefore likewise carried out at elevated pressure, for instance at 40 bar, to avoid desorption of the gas (hydrogen). Otherwise, renewed adsorption processes in the storage vessel could lead to an increase in the temperature and consequently to a shorter period of operation or lower loading density and, in the case of a mobile tank system in a vehicle, thus to a shorter range of the vehicle. Loading at the supply system at pressures of greater than 40 bar, with the pressure then being able to be reduced to 40 bar on filling of the storage container, would also be conceivable. As a consequence, part of the adsorbed gas (hydrogen) would be desorbed from the sorption material and the temperature in the storage container would drop below 77 K. At a lower temperature in the storage container, a larger amount of gas (hydrogen) or the period of operation of the tank system could be increased at the same pressure (40 bar).

The present invention advantageously enables recycling of the energy carrier gas to be achieved when using pressure bodies having poor thermal conductivity (e.g. CFC materials) by means of precooled hydrogen. The external loading of the storage material with hydrogen and the resulting elimination of evolution of heat in the storage container (dQ/dt; dt<10 min) lead to the volume flows required for introduction of cold to be significantly lower and these are then in the approximate order of magnitude of the heat flows required for desorption (dQ/dt; dt˜some hours=several hundred kilometers) so that the apparatuses and cross sections required for transport of heat and material can be significantly reduced. This results in a weight saving and also a reduction in the complexity of the storage system. As a consequence, the production costs and the capital costs and the operating outlays decrease with a simultaneously increased period of operation (“boil-off time”) due to the lower heat flow via the narrower tube connections.

The invention will now be illustrated with the aid of examples with reference to the accompanying drawings. In the drawings:

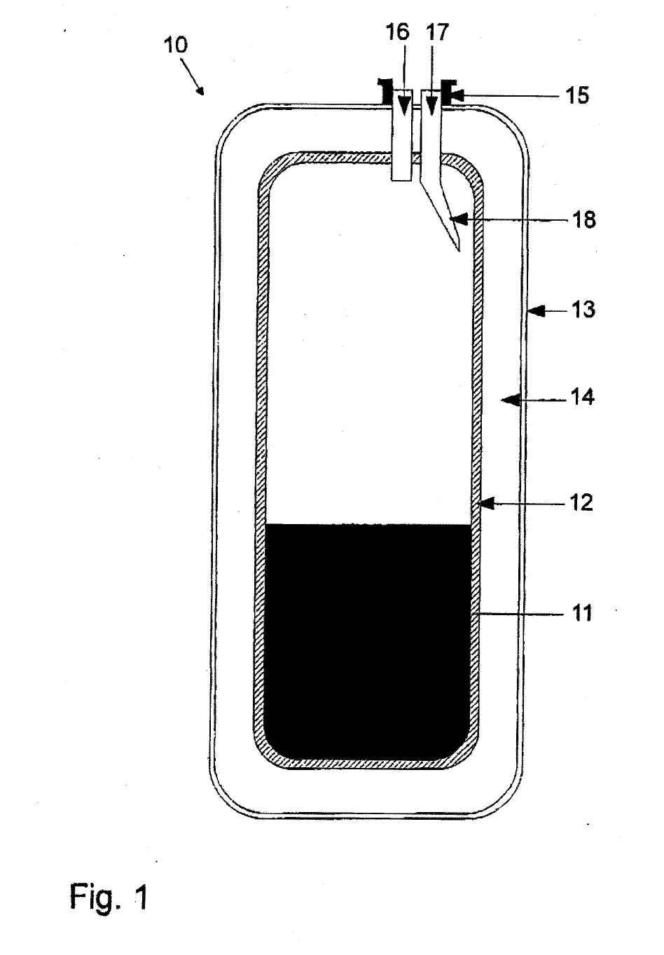

FIGS. 1 to 4 show a first embodiment of a storage container according to the invention;

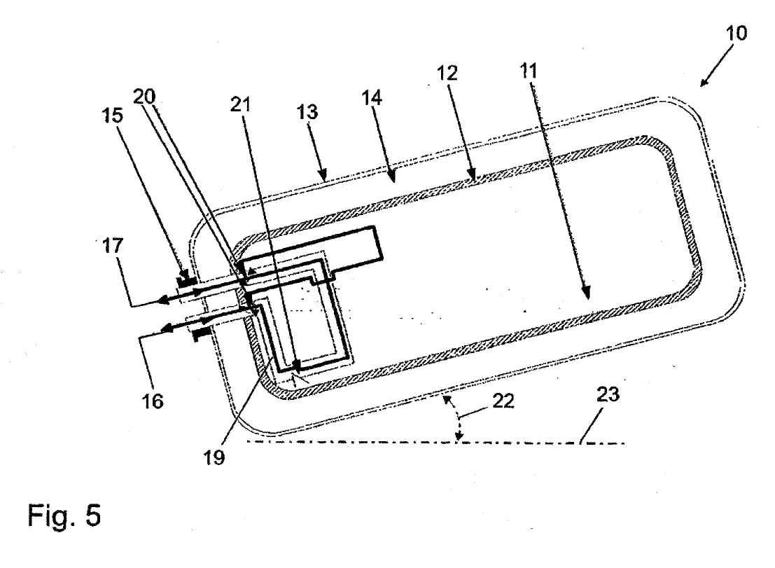

FIGS. 5 to 8 show a second embodiment of a storage container according to the invention;

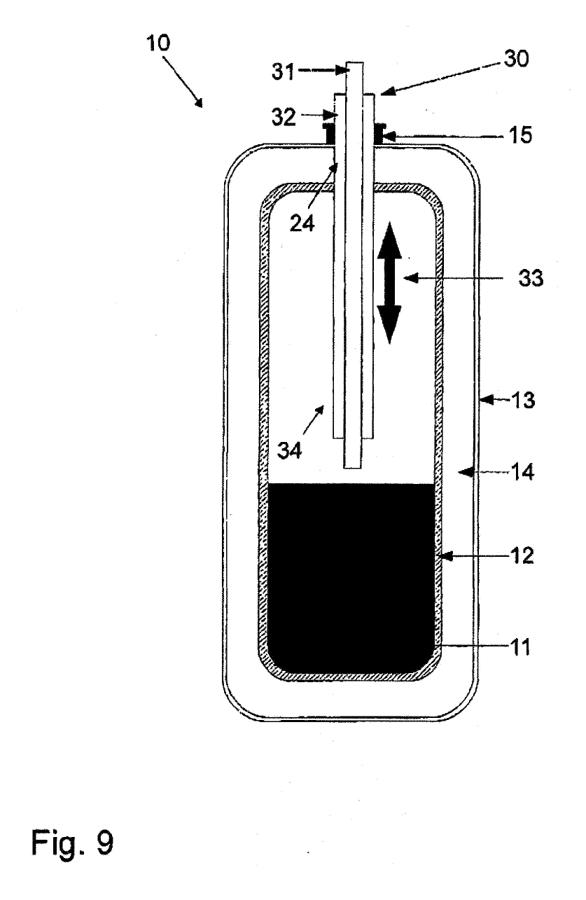

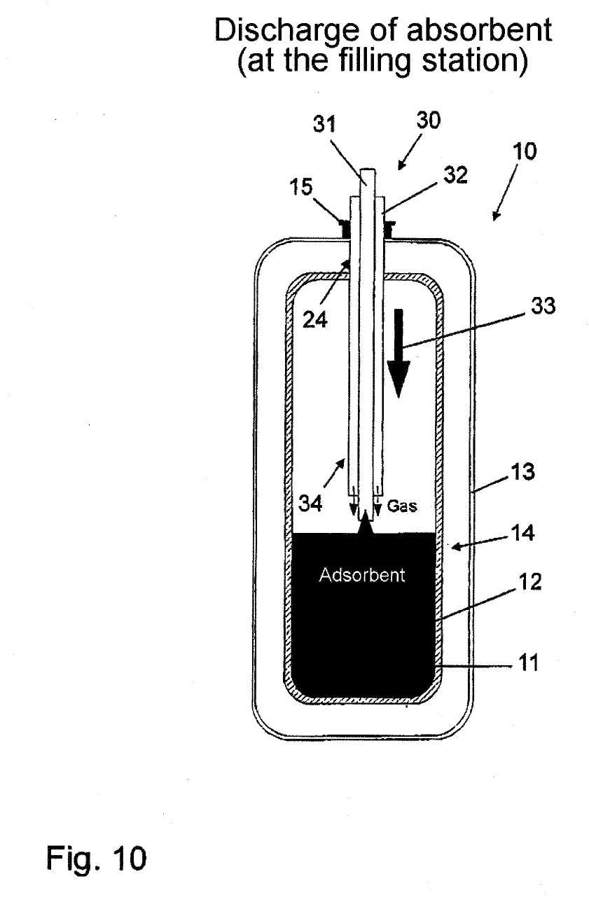

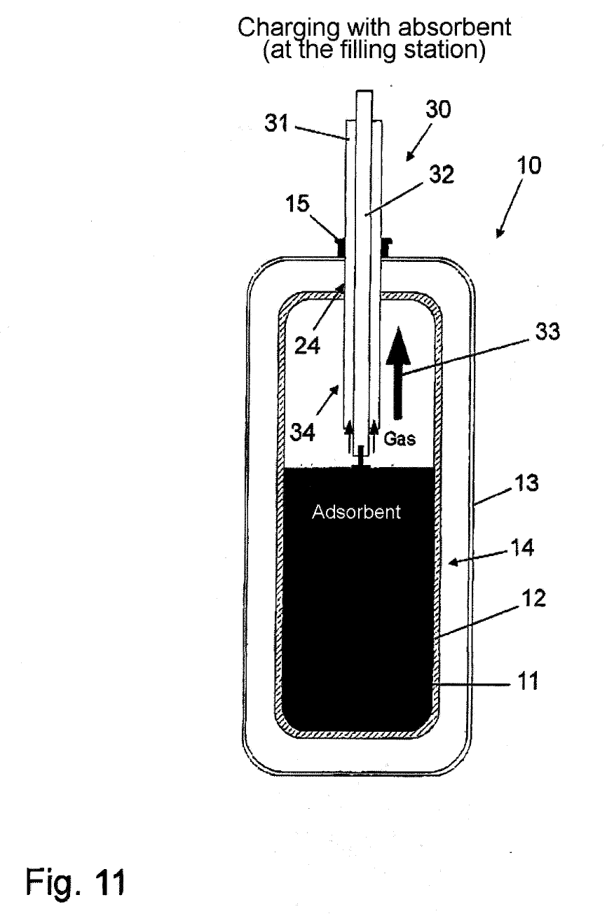

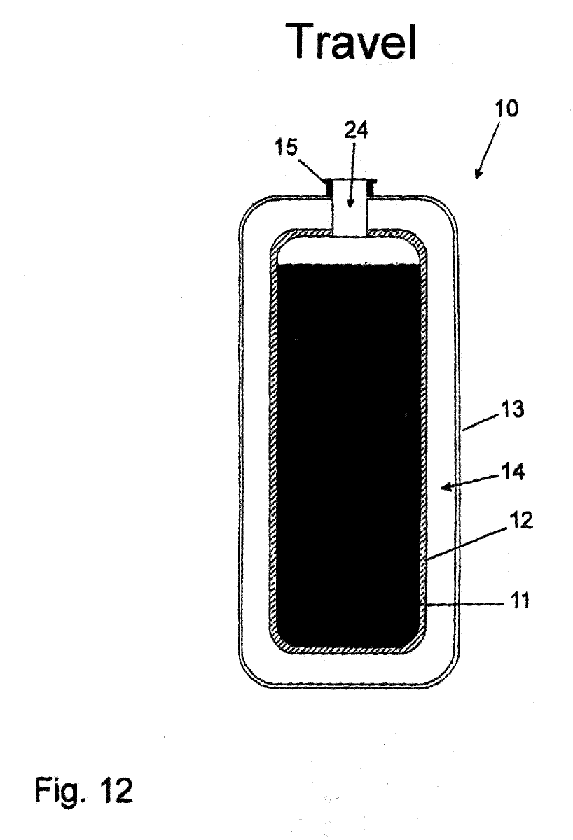

FIGS. 9 to 12 show a third embodiment of a storage container according to the invention;

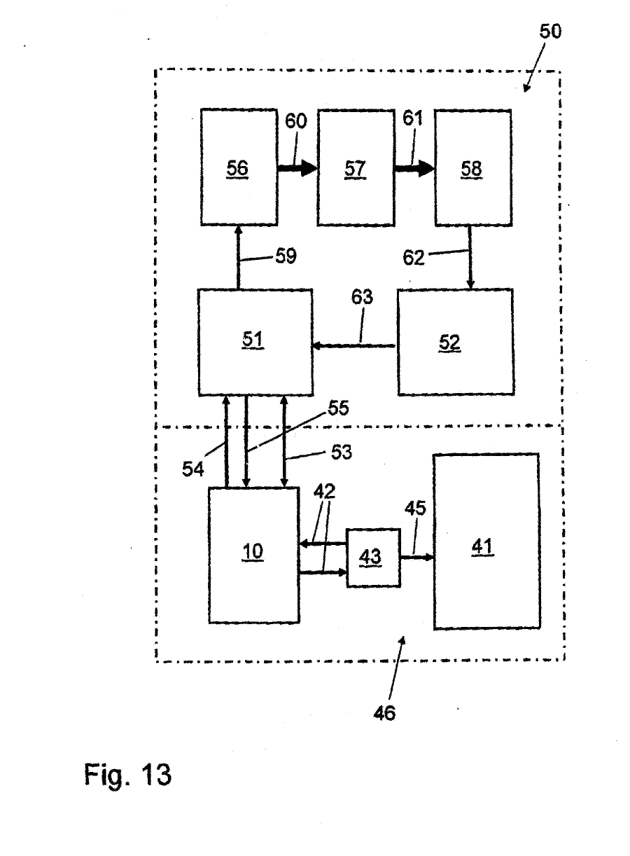

FIG. 13 shows a schematic view of a tank system according to the invention which operates together with a system according to the invention for providing a sorption material; and

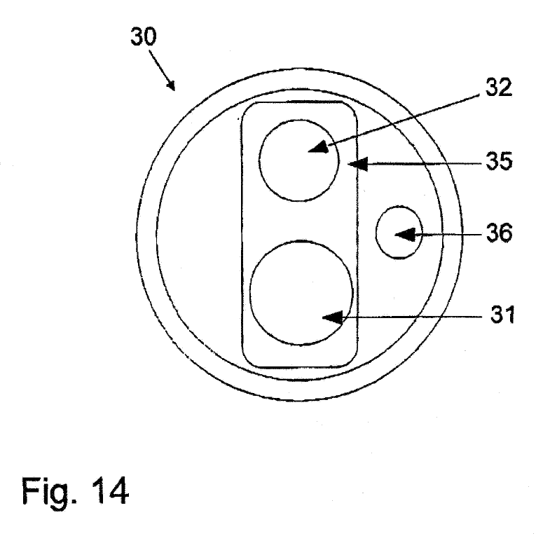

FIG. 14 shows a schematic cross-sectional view of a charging/discharging connection according to the invention.

The examples describe a situation in which a sorption material onto which hydrogen is adsorbed is introduced into a storage container 10. The storage container is a constituent of a mobile tank system which is installed in a vehicle. The storage container is charged at a supply system which represents a filling station.

Firstly, FIGS. 1 to 12 show various examples of a storage container 10 and likewise its charging and discharging operations.

The storage container 10 shown in FIGS. 1 to 4 is in the form of a pressure vessel. The storage container 10 firstly has an inner container 12 in which a sorption material 11 is present. The sorption material 11 comprises a sorbent on which hydrogen is adsorbed. The inner container 12 is surrounded by an outer container 13, with an insulation region 14 being provided between the two containers 12, 13. The storage container 10 also has a connecting element 15, for example a flange, via which it can be connected to an external supply system. In addition, the storage container 10 has a first duct 16 which serves as transport duct for the sorption material. A second duct 17 which serves as gas duct is additionally provided. In the present example, this gas duct 17 is configured as a nozzle 18.

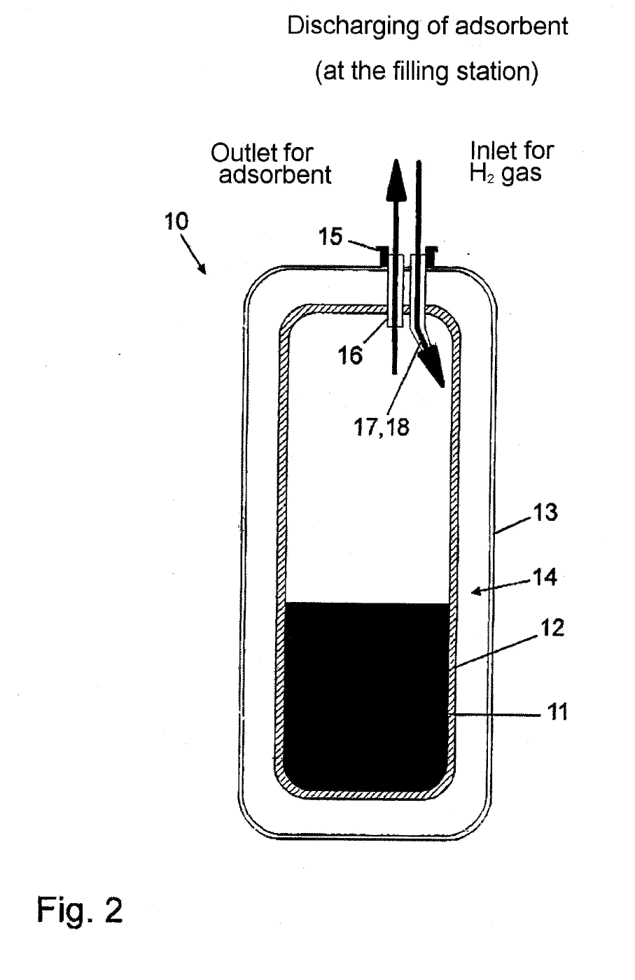

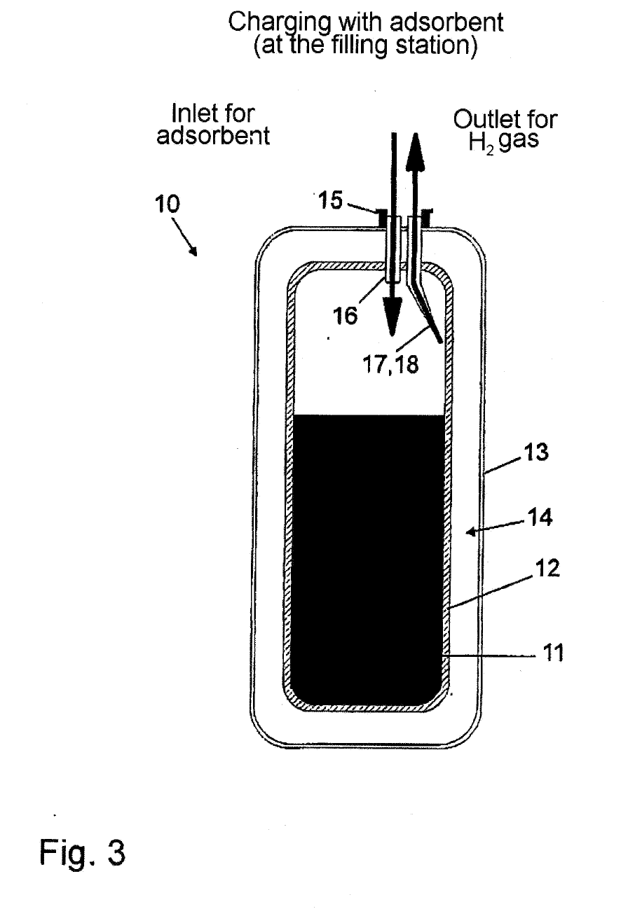

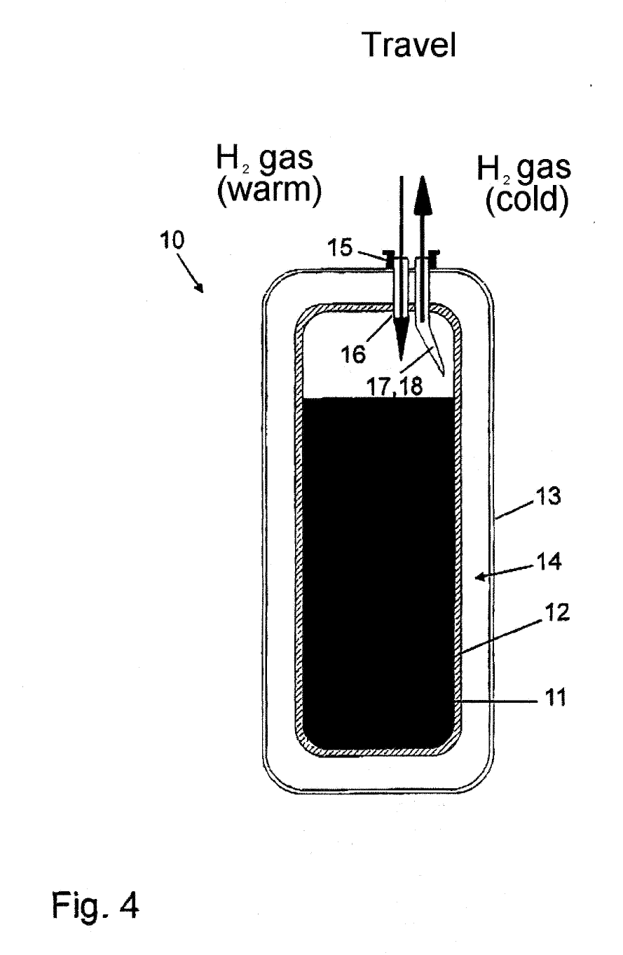

The objective of this embodiment is a mechanically simple charging and discharging system in order to avoid complicated constructions and movable parts within the storage container 10. The basic idea is to transport the granular sorption material 11 by means of a gas stream at virtually any pressure up to about 40 bar. The tank system should for this purpose basically have two openings/ducts. The first duct 16 (transport duct) is provided with a comparatively large diameter relative to the particle size of the sorption material (for example diameter=50×particle size). The duct 16 serves to transport the sorption material 11 both from the filling station to the tank system and also from the tank system to the filling station. The second duct 17 (gas duct) is configured in the form of a nozzle 18 and has a filter which holds back intruding sorption material particles. This nozzle 18 serves as gas outlet when charging the tank system. When charging the tank system (FIG. 3) with fresh sorption material 11, the latter is introduced by means of a volume flow via the first duct 16 into the storage container 10. The hydrogen carrier gas required for this purpose leaves the storage container 10 via the gas duct 17. During discharging (FIG. 2) of the tank system, hydrogen gas flows via the duct 17 configured as a nozzle 18 into the storage container 10. The high flow velocity at the outlet and the position of the nozzle 18 in the storage container 10 results in sorption material 11 present in the storage container 10 being fluidized and transported from the storage container 10 through the transport duct 16 by means of the gas flow. The tank system can be charged and discharged in this way. During travel (FIG. 4), desorbed hydrogen is taken off via the gas duct 17 and fed to the drive apparatus. To control desorption in an optimal fashion, warmed hydrogen can be introduced into the storage container 10 via the transport duct 16.

The storage container 10 shown in FIGS. 5 to 8 is likewise in the form of a pressure vessel. The storage container 10 once again has an inner container 12 in which the sorption material 11 is located. The sorption material 11 comprises a sorbent on which hydrogen is adsorbed. The inner container 12 is surrounded by an outer container 13, with an insulation region 14 being provided between the two containers 12, 13. The storage container 10 also has a connecting element 15, for example a flange, via which it can be connected to an external supply system. In addition, the storage container 10 has a first duct 16 which serves as transport duct for the sorption material 11. A second duct 17 which serves as gas duct is additionally provided. In the present example, the two ducts 16, 17 are tubular and form a tube loop 19. Two rotatable flaps 20 are arranged in the tube loop 19 in order to influence the flow within the tube loop 19.

The embodiment of the storage container 10 shown in FIGS. 5 to 8 makes use of the dynamic pressure drop at places having an increased flow velocity in accordance with the Bernoulli equation

$$\frac{1}{2} ρ {v}^{2} + ρ gh + P = const .$$

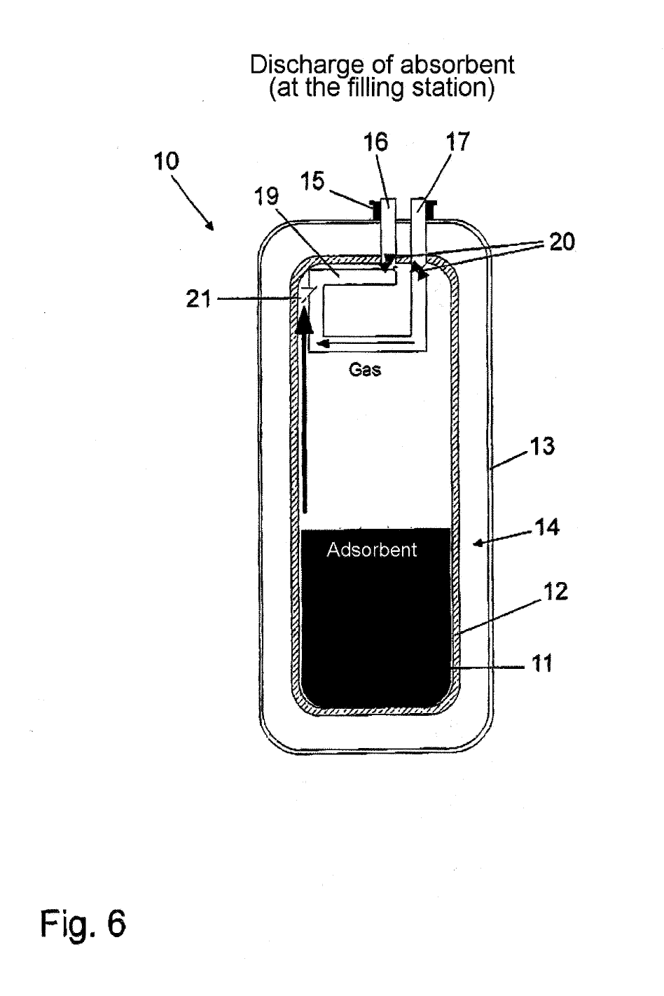

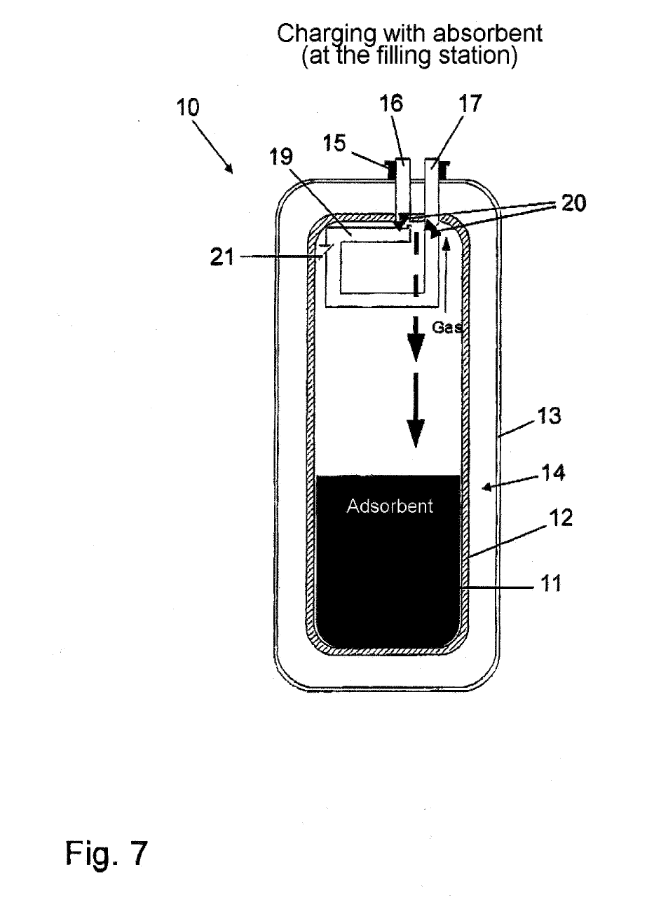

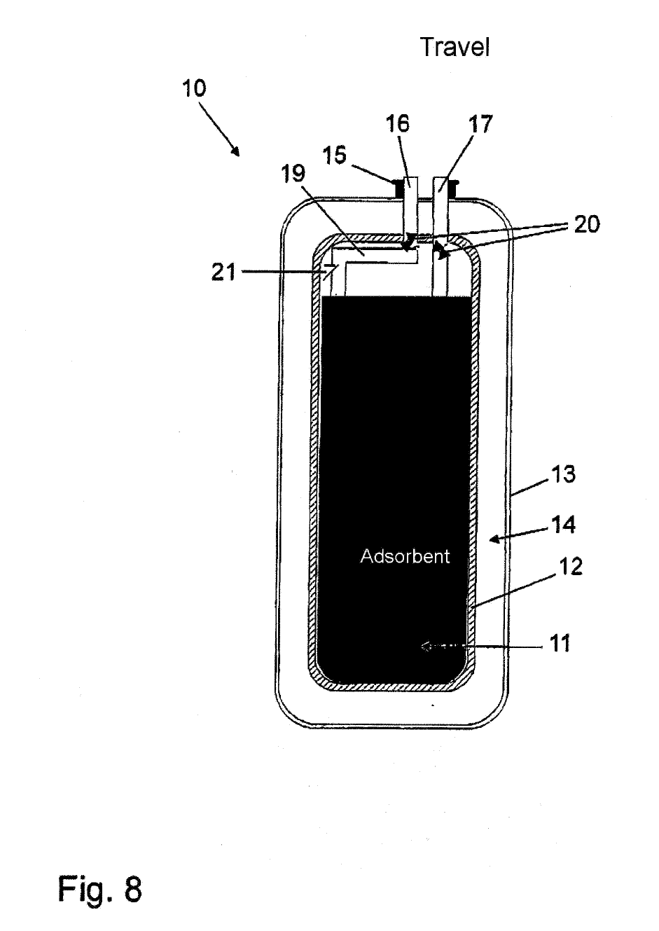

(Venturi tube). The storage container 10 has a closed tube loop 19 having a very low internal flow resistance and is interrupted at two places by flow-driven flaps 20 which can be rotated through 90°. The objective of these flaps 20 is to divert the transport stream (sorption material+carrier gas) during the charging operation. The first flap closes the passage through the tube system and thereby brings about introduction of the sorption material 11 into the storage container (FIG. 7). The carrier gas is conveyed via the second flap back into the tube system and can be returned to the fuel dispenser. A filter upstream of the flap 20 prevents discharge of sorption material 11. During emptying of the storage container 10 (FIG. 6), the carrier gas flows through the tube loop 19 in the opposite direction. A constriction 21 in the tube loop (see the above-described Venturi principle) leads to a reduction in the static pressure in the pipe section and thus to sucking-out of sorption material 11 from the storage container 10. The sorption material 11 is dispersed in the carrier stream and discharged from the storage container 10. A slightly slanted position 22 of the storage container 10 and appropriate positioning of the Venturi subsection 21 in the vicinity of the lowest point enable gravity on the slanted plane to transport the sorption material 11 to within the reach of the suction. Here, the slanted position is relative to a reference plane 23 which in the present example is a horizontal plane. Whether the reference plane is a horizontal or vertical plane depends on the general alignment of the storage container 10. During travel (FIG. 8), desorbed hydrogen is taken from the storage container 10 via the gas duct 17.

The storage container 10 shown in FIGS. 9 to 12 is also in the form of a pressure vessel. The storage container 10 once again has an inner container 12 in which the sorption material 11 is located. The sorption material 11 comprises a sorbent on which hydrogen is adsorbed. The inner container 12 is surrounded by an outer container 13, with an insulation region 14 being provided between the two containers 12, 13. The storage container 10 also has a connecting element 15, for example a flange, via which it can be connected to an external supply system.

An advantage of the embodiment shown in FIGS. 9 to 12 is the decoupling of the components necessary for charging and discharging from the storage container 10 and thus a significant saving of weight and heat capacity. The task of introducing and discharging sorption material 11 and carrier gas is performed by a charging/discharging connection 30 which is inserted through the tank connection 15 and can also be flexible in its end region 34 which projects into the storage container 10 and is characterized in that the length of the connection 30 in the storage container 10 can be adjusted in order to fluidize and be able to discharge the sorption material 11 in very close proximity. This adjustability is shown in the form of an arrow 33 in FIGS. 9 to 12.

An advantage here is the particular suitability of this embodiment for concentric arrangement of transport duct 31 and gas duct 32. The storage container 10 then has a single duct 24 through which the two other ducts 31, 32 of the connection 10 can be inserted. The adjustable, spatial proximity of the ducts 31, 32 to the sorption material 11 also makes it possible to integrate a suction action in the ducts 31, 32, so that the recirculation of hydrogen is not absolutely necessary for emptying the storage container 10. It could be advantageous, for example, to utilize the Bernoulli principle described in connection with FIGS. 5 to 8, but outside the storage container 10, to discharge the material.

FIG. 13 depicts a scheme which firstly shows a mobile tank system 40 which is intended to be located in a vehicle. The tank system 40 firstly has a storage container 10 which can, for example, be configured in one of the variants shown in FIGS. 1 to 12. The storage container 10 is connected via appropriate ducts 42 to a heat-exchange apparatus 43 which is in turn connected via line 45 to a drive apparatus 41 of the vehicle.

There are a number of options for taking hydrogen from the mobile tank system 40. The amount of hydrogen stored in the storage container 10 is made up of the adsorbed phase (H_{ads}), i.e. the hydrogen adsorbed on the sorbent, and the gas phase (H_{gas}), i.e. the hydrogen gas present in the free volume of the tank 10. For any state (temperature and pressure), an equilibrium depending on the adsorption properties of the sorbent is established. Immediately after filling the tank of the vehicle (pressure in the tank system: 40 bar; temperature: 77 K), the hydrogen required by the drive unit 41 of the vehicle can be taken directly from the gas phase. This hydrogen is available virtually immediately in an amount determined by the pressure prevailing in the storage container 10. As a result of hydrogen being taken from the gas phase, the equilibrium between adsorbed phase and gas phase in the tank 10 is disturbed. As the pressure decreases, part of the adsorbed hydrogen is then desorbed in order to partly make up the loss from the gas phase. However, the decreasing temperature caused by desorption in turn slows the desorption process. When hydrogen is briefly taken from the gas phase of the storage container 10, the pressure decreases, for example, from 40 bar to 38 bar, with the temperature dropping from, for example, 77 K to 65 K because of the negligible heat flow from the surroundings through the insulation (the size of the decrease is ultimately dependent on the adsorption enthalpies and properties of the sorbent). The hydrogen is thus continually taken from the gas phase in order to supply the drive unit 41 of the vehicle. However, as soon as the pressure in the storage container 10 drops below the pressure required by the consuming apparatus, a volume flow of hydrogen required by the drive unit 41 of the vehicle can no longer be maintained (for example at a pressure of 2 bar). The pertinent values are, however, dependent on the sorbent used in the particular case.

The supply of hydrogen can be ensured by means of an attached pump (disadvantage: consumer of electricity!) or preferably by means of a targeted increase in the temperature in the storage container 10. This can advantageously be achieved by warming cold hydrogen which has been taken off by means of a heat exchanger 43 which preferably utilizes the heat of the surroundings and introducing it back into the storage container 10 where the heat capacity stored in the gas is transferred to the sorption material (recycling). The heat input can be controlled, for example, by means of two magnetic valves positioned on the storage container 10 which interrupt the line in order to avoid undesirable input of heat in the case of, for example, the vehicle not being used. The recycling system presented enables the temperature in the tank system 40 to be increased without use of electric heating, and the hydrogen present in the adsorbed phase can thus also be desorbed and utilized when required.

The storage container 10 can be supplied with sorption material 11 from a system 50 for providing a sorption material 11, in the present case a filling station. For this purpose, the storage container 10 is connected to a charging apparatus 51 during charging and discharging, as indicated by the arrows 54 and 55. The charging apparatus can be a type of fuel dispenser of the filling station system 50. Furthermore, a data conduit 53 in the form of suitable interfaces can be present between the mobile tank system 40 and the supply system 50, via which, in particular, measured values can be exchanged and can advantageously aid the charging and discharging processes. The charging apparatus 51 is connected via a connecting line 63 to a storage facility 52 in which loaded sorption material is temporarily stored.

The sorption material which has been discharged via the charging apparatus 41 can, for example, be passed via a facility 56 for quality control and a facility 57 for regeneration to a facility 58 for loading a sorbent and/or sorption material and subsequently, after loading is complete, be temporarily stored in the storage container 52 until it is used further. This transport route of the sorption material is shown by the arrows 59, 60, 61 and 62 in FIG. 13.

Fully unloaded sorbent or partly unloaded sorption material retained in the mobile tank system 40 could be dealt with in two ways in the system 50.

Retained, fully unloaded sorbent or partly unloaded sorption material could firstly be assessed by quality control in the facility 56. Here, particles which may have been damaged or be unusable could be sorted out.

The sorbent and/or sorption material could be regenerated (heat-treated/baked) in the facility 57 in order to remove gaseous impurities, for example from secondary constituents of the gas used. Regular regeneration thus makes it possible, for, example, to utilize hydrogen having a lower quality/purity (for example purity class 3.0 instead of class 5.0) without significant disadvantages.

The sorbent/sorption material can be cooled (77 K) and once again be loaded with hydrogen and made available again at the fuel dispenser. This occurs in the facility 58. It is energetically advantageous to cool and load the sorbent/sorption material gradually in discrete processes or continuously. A series of temperature steps could, for example, be as follows: 0° C./−40° C./−80° C./−120° C./−160° C./−196° C. It may also be useful to couple the temperatures to known phase transitions, e.g. CO_{2solid}→CO_{2gas} (sublimation). Varying the loading pressure can also, depending on the adsorption behavior of the materials, help to save energy.

Another possibility is to cool and load retained, partly unloaded sorbent/sorption material without quality control or regeneration and make it available again at the fuel dispenser. If appropriate, a readable and writeable chip integrated into the tank system 40 can ensure that quality control is carried out independently of the loading state in an appropriate cycle (for example at each fifth filling of the tank).

An example of a suitable charging/discharging connection 30 which can be used in the system 50 in order to connect to the storage container 10 of the tank system 40 is described with reference to FIG. 14. A dispensing connection suitable for the system advantageously has the following properties:

It has a thermal insulation 35 in order to prevent undesirable input of heat into the cold gases and the cold sorption material (preferably 77 K). Furthermore, a first duct, namely a transport duct 31, is provided. This transport duct 31 serves as duct for sorption material particles which are transported by a gas stream. The transport duct 31 preferably has a round cross section, with the diameter advantageously corresponding to many times the size of the particles to be transported. Furthermore, a second duct for gas, namely a gas duct 32, is provided. This duct 32 is provided only for gas transport and is protected by means of filters against the intrusion of sorption material particles. As an alternative, both ducts 31, 32 could be suitable for the transport of sorption material. In this way, cooled transport medium can always be transported via one of the two ducts 31, 32, preferably insulated ducts, during charging and discharging of the storage container. This makes it possible to avoid losses which would otherwise occur when using a warm duct for a cold medium. (Medium warms up/sorption material desorbs gas on warming).

An interface 36 for an electric data connection which allows information exchange between the filling station 50 and the tank system 40 of the vehicle or the vehicle itself can also advantageously be provided. It would be possible to transmit, for example, the type of sorption material, the loading state, the pressure, the temperature and the like.

Events which occur during a tank filling operation are described by way of example below. Here, the following initial situation should be assumed:

A vehicle reaches the filling station in, for example, the following state:

Residual pressure in the tank system less than 5 bar
Temperature in the tank system greater than 0° C.

This means that the tank system 40 of the vehicle contains granular or precompacted, loose sorption material which is partly loaded with hydrogen (the amount of adsorbed hydrogen is dependent on temperature and pressure in the tank system 40 and on the amount and adsorption properties of the sorption material used) and also unadsorbed, gaseous hydrogen (the amount of gaseous hydrogen can be determined by pressure, temperature and/or free volume present in the tank).

To commence the tank filling operation, the charging connection 30 is attached to the connecting flange 15 of the storage container 10. The residual amount of stored hydrogen is subsequently determined by measuring pressure and temperature within the tank system 40 of the vehicle.

The sorption material present in the tank 10 of the vehicle is then discharged by blowing in hydrogen. The specific shape and position of the nozzle 18 (FIG. 1) results in the pulverulent sorption material 11 being fluidized and discharged through the outlet (gas duct 17) by means of the gas stream. The pressure of this discharging circuit does not necessarily have to be 40 bar but can, for example, be matched to the residual pressure in the tank 10 in order to prevent adsorption or further desorption on/from the sorption material 11 during the discharging operation.

After removal of an advantageous proportion of the sorption material 11 (for example about 98%) the tank system (i.e. the empty storage container 10) of the vehicle is cooled by blowing in cold (77 K) hydrogen. Here, cold (77 K) hydrogen gas is blown at an appropriate flow velocity and volume flow from the filling station 50 via the duct 16 provided for introduction of gas into the storage container 10, with the heat flow dQ/dt from the pressure vessel (inner container 12 of the storage container 10) to the cold hydrogen gas removing heat which is then transported away by discharge of the now warmed hydrogen gas from the storage container 10 of the vehicle through the duct 17 provided for this purpose.

Fresh sorption material 11 which is fully loaded with hydrogen is then blown in at a pressure of, for example, 40 or 100 bar via the duct provided for charging (transport duct 16). The sorption material 11 has been precooled to 77 K and loaded with hydrogen at 40 bar in the filling station 50. Transport of the sorption material 11 from the filling station 50 into the tank system 40 at 40 bar is therefore necessary to avoid desorption of hydrogen. Otherwise, renewed adsorption processes in the tank system 40 of the vehicle could lead to an increase in the temperature and consequently to a shorter period of operation or lower loading density and thus to a shorter range of the vehicle. It would also be conceivable to carry out loading at the filling station 50 at pressures of greater than 40 bar, with the pressure on filling the tank system 40 being able to be reduced to 40 bar. Part of the adsorbed hydrogen would consequently be desorbed from the sorption material and the temperature in the storage container 10 would drop below 77 K. At a lower temperature in the storage container 10, a larger amount of hydrogen could be stored or the period of operation of the tank system 40 could be increased at the same pressure (40 bar).

After complete charging of the storage container 10 with sorption material 11 at 40 bar, the tank filling operation is complete. The vehicle can be decoupled from the filling station and continue its journey.

Further embodiments, modifications and variations of the present invention can readily be recognized and performed by a person skilled in the art on reading the description without going outside the scope of the present invention.

### LIST OF REFERENCE NUMERALS

10 Storage container
11 Sorption material
12 Inner container
13 Outer insulation container
14 Insulation region
15 Connecting element
16 Transport duct
17 Second duct (gas duct)
18 Nozzle
19 Tube loop
20 Rotatable flap
21 Venturi subsection
22 Slanted position
23 Horizontal plane
24 Duct
30 Charging/discharging connection
31 Transport duct
32 Gas duct
33 Positioning dependent on the fill level
34 End region of the charging/discharging connection
35 Thermal insulation
36 Interface (data connection)
40 Tank system
41 Drive apparatus
42 Duct
43 Heat-exchange apparatus
45 Line
46 Vehicle
50 System for providing a sorption material (filling station)
51 Charging apparatus
52 Storage facility
53 Data interface
54 Discharging operation
55 Charging operation
56 Facility for quality control
57 Facility for regeneration
58 Facility for loading a sorbent and/or sorption material
59 Transport route of the sorption material
60 Transport route of the sorption material
61 Transport route of the sorption material
62 Transport route of the sorption material
63 Connection between charging apparatus and storage facility

1-45. (canceled)

46. A storage container for storing a sorption material and having
a pressure vessel,
a connecting element to an external supply system,
at least one sorption material which at least during operational use of the storage container is accommodated in the latter and
a transport duct for charging and/or discharging the storage container with sorption material,
wherein the sorption material comprises a sorbent and an adsorbate selected from a gaseous fuel adsorbed thereon,
wherein at least one second duct for introducing and/or discharging a gas (gas duct) is provided and
wherein the sorbent is based on high-performance adsorbents based on activated carbon in the form of discrete activated carbon grains where at least 70% of the total pore volume of the high-performance adsorbents is formed by micropores having pore diameters of ≦20 Å.

47. The storage container as claimed in claim 46, wherein the high-performance adsorbents have an average pore diameter of not more than 30 Å;
wherein the high-performance adsorbents have a BET surface area of at least 1 500 m²/g;
wherein the high-performance adsorbents have a total pore volume determined by the Gurvich method of at least 0.7 cm³/g, with at least 70% of this total pore volume being formed by micropores having pore diameters of 20 Å.

48. The storage container as claimed in claim 46,
wherein the total pore volume determined by the Gurvich method of the high-performance adsorbents is in the range from 0.7 to 1.8 cm³/g;
wherein at least 75% of the total pore volume determined by the Gurvich method of the high-performance adsorbents is formed by micropores having pore diameters of ≦20 Å;
wherein the micropore volume determined by the carbon black method of the high-performance adsorbents formed by micropores having pore diameters of ≦20 Å is in the range from 0.5 to 1.4 cm³/g.

49. The storage container as claimed in claim 46,
wherein the average pore diameter of the high-performance adsorbents is in the range from 15 to 30 Å and
wherein the BET surface area of the high-performance adsorbents is in the range from 1,500 m²/g to 3,500 m²/g.

50. The storage container as claimed in claim 46, wherein the storage container has an inner container for accommodating the sorption material and an outer insulation container surrounding the inner container with an insulation region being provided between the inner container and the outer container.

51. The storage container as claimed in claim 46, wherein the transport duct and/or the gas duct is/are tubular or wherein the transport duct and/or the gas duct is/are configured in the form of a nozzle.

52. The storage container as claimed in claim 46, wherein the storage container is configured as a storage tank for hydrogen.

53. A tank system, in particular a mobile tank system, for providing a gaseous fuel for a drive apparatus, the tank system comprising at least one storage container as claimed in claim 46.

54. The tank system as claimed in claim 53, wherein the storage container is connected via a duct to a heat-exchange apparatus.

55. The tank system as claimed in claim 53, wherein at least one interface for transmitting values measured by at least one sensor element for measuring operation-specific properties of the storage container and/or of the sorption material and/or of the sorbent is provided.

56. A charging/discharging connection for charging or discharging a storage container as claimed in claim 46, wherein the charging/discharging connection has
a first duct for conveying a sorption material comprising a sorbent and an adsorbate selected from a gaseous fuel adsorbed thereon and as defined in claim 46, where the first duct can be connected to a transport duct of a storage container, and
a second duct for conveying a gas, which can be connected to a gas duct of the storage container.

57. The charging/discharging connection as claimed in claim 56,
wherein the first duct and/or the second duct is/are thermally insulated; and
wherein the first duct and the second duct are arranged next to one another with a spacing between them or wherein the first duct and the second duct are arranged concentrically within or around one another.

58. The charging/discharging connection as claimed in claim 56,
wherein the charging/discharging connection is flexible at least in regions in its end region which is brought into contact with a storage container or can be inserted in the latter; and
wherein the charging/discharging connection has an interface for receiving data and/or for transmitting data.

59. A system for providing a sorption material and comprising a sorbent and an adsorbate selected from a gaseous fuel adsorbed thereon for a storage container,
wherein a charging apparatus which has a device for discharging exhausted sorption material present in a storage container and a device for charging a storage container with unexhausted sorption material is provided; and
wherein a storage facility for storing sorption material which is to be supplied to a storage container, which storage facility is connected at least part of the time to the charging apparatus, is provided.

60. The system as claimed in claim 59,
wherein the charging apparatus is configured for filling a storage container with sorption material at a pressure above ambient pressure; and
wherein the charging apparatus has a charging/discharging connection.

61. A method of providing a sorption material for a storage container by means of a system as claimed in any of claim 59, wherein exhausted sorption material present in a storage container is discharged from the storage container, wherein the sorption material is loaded again with a gas outside the storage container and wherein the loaded sorption material is subsequently made available again for a storage container.

62. The method as claimed in claim 61, wherein the sorption material loaded with the gas is temporarily stored in a storage facility until it is used further and/or wherein the exhausted sorption material discharged from the storage facility is subjected to quality control before being loaded again with a gas.

63. The method as claimed in claim 61, wherein the exhausted sorption material discharged from the storage facility is subjected to a regeneration process before being loaded again with a gas and/or wherein the sorption material is cooled to a predetermined temperature before being loaded again with gas.

64. A method of charging a storage container as claimed in claim 46 with a sorption material as defined in claim 46, wherein exhausted sorption material present in a storage container is firstly discharged from the storage container and the storage container is subsequently charged with unexhausted sorption material.

65. The method as claimed in claim 64, wherein the discharging and charging of the storage container is carried out by means of a system as claimed in any of claim 59 and/or wherein the storage container is charged with a sorption material which has been provided by means of a method as claimed in claim 61.

66. The method as claimed in claim 64, wherein the residual amount of adsorbate adsorbed on the sorption material and/or unadsorbed gaseous fuel remaining in the storage container is determined before discharging exhausted sorption material from the storage container.

67. The method as claimed in claim 64, wherein the discharging of exhausted sorption material from the storage container is carried out by blowing in gaseous fuel used in respect of the sorption material.
